(19) United States
(12) Patent Application Publication
(10) Pub. No.: US 2021/0244221 A1
(43) Pub. Date: Aug. 12, 2021

(54) Multi-Layer Mat

(71) Applicant: Jerome Philippe Perkins, Centennial, CO (US)

(72) Inventor: Jerome Philippe Perkins, Centennial, CO (US)

(21) Appl. No.: 16/860,903

(22) Filed: Apr. 28, 2020

Related U.S. Application Data
(60) Provisional application No. 62/841,923, filed on May 2, 2019.

(51) Int. Cl. A47G 27/02; B32B 5/02; B32B 5/18; B32B 5/24; B32B 5/16; B32B 5/30; H05B 1/02; G06F 3/0482; G06F 3/0484; G08C 17/02

(52) U.S. Cl. CPC A47G 27/0212; G08C 2201/30; B32B 5/18; B32B 5/245; B32B 5/16; B32B 5/30; H05B 1/0252; G06F 3/0482; G06F 3/04847; G08C 17/02; B32B 2471/04; B32B 2307/73; B32B 2307/7265; B32B 2307/30; B32B 5/02

(57) ABSTRACT

A multi-layer mat includes a multi-layer mat includes a protective layer and a comfort layer. The protective layer is composed of a first material and has a protective layer surface. The comfort layer is composed of a second material, is positioned on top of the protective layer, and has a comfort layer surface parallel to the protective layer surface. In a usage configuration, the multi-layer mat lies flat with the protective layer surface flush against a ground surface and with the comfort layer surface exposed for standing upon by a user. The protective layer is configured to protect the comfort layer from elements of the ground surface in the usage configuration via the first material. The multi-layer mat is configured for manual transition between the usage configuration and a storage configuration via the user, where the comfort layer surface is unexposed in the storage configuration.

### CROSS-REFERENCE TO RELATED APPLICATIONS

The present U.S. Utility patent application claims priority pursuant to 35 U.S.C. § 119(e) to U.S. Provisional Application No. 62/841,923, entitled “PORTABLE MULTI-LAYER MAT”, filed May 2, 2019, which is hereby incorporated herein by reference in its entirety and made part of the present U.S. Utility Patent Application for all purposes.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not applicable

### BACKGROUND OF THE INVENTION

### Technical Field of the Invention

This invention relates generally to mats and sporting equipment.

### BRIEF DESCRIPTION OF THE SEVERAL VIEWS OF THE DRAWING(S)

FIGS. 1-2 present illustrations of a multi-layer mat in accordance with various embodiments of the present invention;

FIG. 3 presents an illustration of a usage configuration of a multi-layer mat in accordance with various embodiments of the present invention;

FIG. 4 presents an illustration of a usage configuration of a multi-layer mat that includes at least one internal layer in accordance with various embodiments of the present invention;

FIGS. 5-6 present illustrations of a multi-layer mat that includes a bordering protective layer in accordance with various embodiments of the present invention;

FIG. 7A presents an illustration of a multi-layer mat that includes at least one strap in accordance with various embodiments of the present invention;

FIGS. 7B-7C present illustrations of a folded storage configuration of multi-layer mat in accordance with various embodiments of the present invention;

FIG. 7D presents an illustration of a multi-layer mat that includes at least one strap in accordance with various embodiments of the present invention;

FIGS. 8A-8B present illustrations a multi-layer mat that includes a hinged partition in accordance with various embodiments of the present invention;

FIGS. 9A-9C present illustrations a multi-layer mat that includes a plurality of weighted fastening components in accordance with various embodiments of the present invention;

FIG. 10 presents an illustration a rolled storage configuration of multi-layer mat in accordance with various embodiments of the present invention;

FIGS. 11A-11B present illustrations of a multi-layer mat that includes a top protective layer in accordance with various embodiments of the present invention;

FIGS. 12A-12B present illustrations of a reversible comfort layer in accordance with various embodiments of the present invention;

FIGS. 12C-12D present illustrations of a multi-layer mat that includes a reversible comfort layer in accordance with various embodiments of the present invention;

FIGS. 13A-13C present illustrations of a multi-layer mat that includes at least one foot cavity in accordance with various embodiments of the present invention;

FIGS. 14A-14B present illustrations of a multi-layer mat that includes an exposed protective surface in accordance with various embodiments of the present invention;

FIGS. 15-16 present illustrations of a storage compartment in accordance with various embodiments of the present invention;

FIG. 17 presents an illustration of a multi-layer mat that includes a storage compartment in accordance with various embodiments of the present invention;

FIGS. 18A-18B present illustrations of a multi-layer mat that includes a heating element in accordance with various embodiments of the present invention;

FIG. 19 presents an illustration of a multi-layer mat that includes visual markers above discretely positioned heating elements in accordance with various embodiments of the present invention;

FIG. 20 is a schematic block diagram illustrating a heating element control system in accordance with various embodiments of the present invention;

FIG. 21A presents an illustration of a multi-layer mat with a heating element control system that receives user selection data from a client device in accordance with various embodiments of the present invention;

FIG. 21B is a schematic block diagram illustrating a client device in accordance with various embodiments of the present invention;

FIGS. 22-23 present illustrations of a heating element compartment in accordance with various embodiments of the present invention; and

FIG. 24 presents and illustration of a multi-layer mat that includes a heating element compartment in accordance with various embodiments of the present invention.

### DETAILED DESCRIPTION OF THE INVENTION

When engaging in outdoor, athletic, and/or physical activities, a user may wish to change footwear and/or clothing before and/or after their activity. These activities can include, for example, skiing, snowboarding, snowshoeing, hiking, biking, golfing, swimming, and/or running. After parking their car in a parking lot of a trailhead, a race or athletic event, and/or a ski resort, a person may wish to change into their footwear and/or clothing necessary to engage in the activity in the parking lot next to their car and/or otherwise outdoors near the start of their activity. For example, the user may wish to change from casual shoes into ski boots, snowboarding boots, snow boots, hiking boots, golf shoes or other activity-specific footwear upon arrival, as this footwear may not be safe for driving to the activity and/or may not be comfortable to be worn while in their vehicle. Once the activity has completed and the person has returned to their vehicle and/or start point, the person may wish to change back into their original footwear or clothing, or other comfortable footwear of clothing they brought with them to change into after the activity. The person may also wish to dry their feet if wet from water or sweat prior to applying the footwear for the activity and/or after removing footwear once the activity is completed.

This scenario presents problems, as parking lots and/or trailheads are often uncomfortable and inconvenient places for people to change their footwear and/or other clothing. Exposing bare feet or feet only protected by socks to dirt, sand, ice, snow, sharp rocks and/or twigs, or other outdoor conditions of the ground of a trail head or parking lot can be uncomfortable and/or hazardous. Furthermore, particulates such as sand or dirt may stick to the feet while changing footwear, which would introduce discomfort during the activity or after the activity if they are loose in the footwear or pressing against the person's feet while in the footwear. Similarly, the person's feet and/or socks could become wet if the ground is snowy, muddy, or wet, causing the person to have to endure the activity and/or the drive home after the activity with uncomfortable wet feet and/or socks.

Attempting to balance on one foot to prevent contact of bare or socked feet with the ground while changing footwear is also difficult and poses the possibility of injury due to falling over, especially when applying or removing heavy footwear and/or footwear that requires additional time to fully fasten, such as hiking boots, snow boots, or ski boots. This balancing act introduces further difficulties if other garments are also being changed and/or layered, such as pants that cannot be pulled on over footwear and can only be pulled on over bare feet or socked feet. Attempting to change footwear and/or pants in the car can also be cramped and uncomfortable. Even attempting to put on shoes and/or pants while sitting in a car seat with the door open may not be possible in cases where cars are parked very close together in a small parking lot or are parallel parked on a busy street.

A person may attempt to mitigate these problems by resorting to existing products configured to serve other purposes to aid in changing footwear or clothing. For example, towels, blankets, and/or tarps that a person may have handy in the car may be used, but do not resolve the problems of changing in parking lot or trailhead conditions. In particular, towels, blankets, and/or tarps are thin and do not provide any protection from sharp rocks and/or gravel of the ground and/or parking lot when stood upon by a person, and the person's bare feet and/or feet protected only by socks may be harmed or endure discomfort. Furthermore, if the person is changing on very hot pavement on a summer day or on cold snow or ice on a winter day, their unprotected feet may endure uncomfortable and possibly dangerous exposure to the hot or cold ground, as the towels, blankets, or tarps provide minimal or no insulation. Towels, blankets, and/or tarps are also not configured to remain flat against the ground on their own accord, and can become bunched up as the user shuffles their feet while changing footwear and/or can blow away in windy conditions. Towels and blankets would also soak up moisture of a snowy and/or muddy ground, and would rendering the person's feet and/or socks wet and/or dirty in the process.

A person may resort to other existing mats such as car floor mats from their vehicle, bath mats or rugs from their home, spare pieces of carpet, or other existing mats they may repurpose in an attempt to solve this problem. However, these mats are designed for indoor use, and are not built for more rugged use in outdoor conditions, especially conditions such as snow, sand, or mud that are likely to be present when the person is intending to ski, hike, swim, or mountain bike. In particular, as these mats are not configured to be placed upon already-wet surfaces, these mats tend to have not protective underside or very thin rubber undersides. The top surfaces of these mats are therefore unprotected them from becoming wet and/or dirty if placed in the snow and/or mud. Similar to towels and blankets, these indoor mats again pose the problem of soaking up moisture of a snowy and/or muddy ground that would render a person's feet and/or socks wet and/or dirty. Furthermore, the thin or nonexistent undersides of these mats do not protect bare feet from sharp rocks and/or gravel, as they are often meant for placement on flat indoor flooring such as hardwood, tile, and/or carpeted floors. Additionally, as these mats are intended for indoor use, their fabric and/or thin undersides can easily become ripped or damaged by placement upon sharp rocks and/or gravel, and/or can melt when the ground is very hot, such as when placed upon parking lot pavement on a summer day. Finally, many of these indoor mats are difficult to store in the trunk of a vehicle, as they have no storage configuration and are only configured to lay flat.

If the person were to instead resort to existing mats such as doormats, garage floor mats, or other, thicker mats intended for outdoor use, the top of these mats could be sharp, hard, and/or otherwise uncomfortable against the user's bare feet or feet protected only by socks, as they are designed to be stood on by a user wearing boots, shoes, or other footwear. While a doormat's sharp and sturdy palmyra fibers or stalks are useful in clearing boots and shoes of dried mud or snow, these palmyra fibers or stalks would be hazardous in drying a person's wet skin of their bare feet, and could cause cuts, skin rashes, or general skin discomfort even when simply stood upon with bare feet. Many outdoor mats are only composed of rubber or plastic materials that would provide minimal aid in drying wet bare feet. Furthermore, these mats tend to be stiff as they are intended for use on very flat pavement or cement, and may not be flexible enough to accommodate laying flush to more uneven surfaces at a trailhead or in a field. This stiffness can also cause these mats as being even more difficult to store than the indoor mats, as they also do not have storage configurations and are only configured to lay flat. These mats may also be bulky and heavy, and as they are not designed to be portable, may be inconvenient to carry, for example, to and from the car.

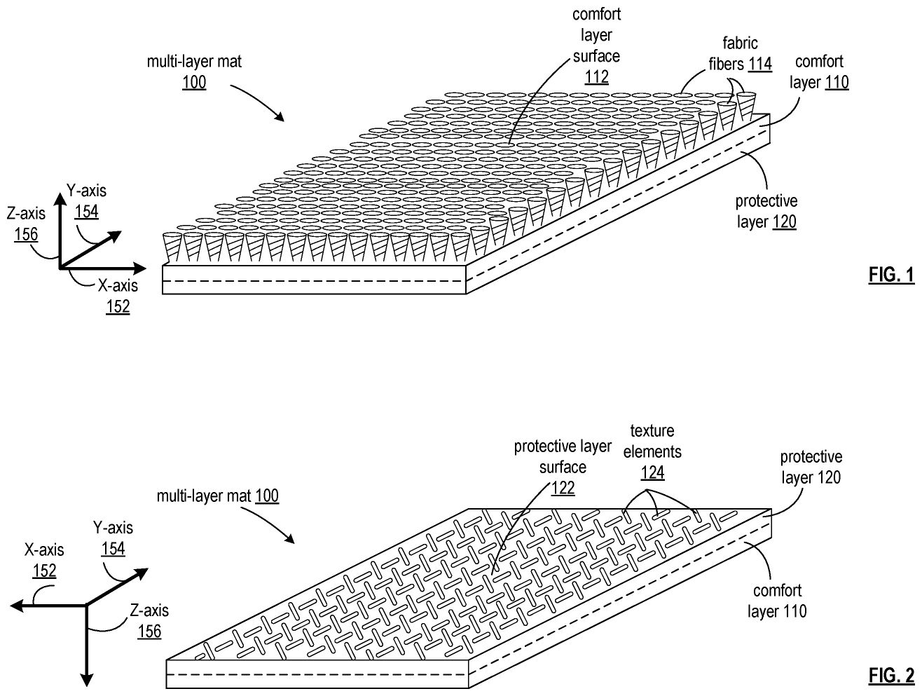

FIGS. 1-24 present various embodiments of a multi-layer mat 100 that presents various solutions to these problems. As discussed in further detail herein, the multi-layer mat 100 can be configured for one or more people to stand on, sit on, and/or squat on while changing their footwear and/or other clothing outdoors. The embodiments presented herein introduce various improvements to the alternatives discussed above to ensure that users can safely and comfortably change their footwear and/or other clothing in various outdoor conditions when in a usage configuration. The embodiments presented herein introduce additional improvements to the alternatives discussed above by enabling the multi-layer mat 100 to be secured in a storage configuration for easy stowing in a car and/or for ease of carrying to a desired place for usage.

FIG. 1 presents a three-dimensional view of an embodiment of a multi-layer mat 100. The multi-layer mat 100 can include a plurality of layers, such as a comfort layer 110 and a protective layer 120. The multi-layer mat can be configured to be placed on the ground, where the protective layer 120 is touching the ground facing downwards, and where the comfort layer 110 is furthest from the ground facing upwards. Thus, the protective layer 120 is configured to lie between the ground and the comfort layer 110. In particular, the ground can be a planar surface to facilitating laying of the multi-layer mat flat upon the ground.

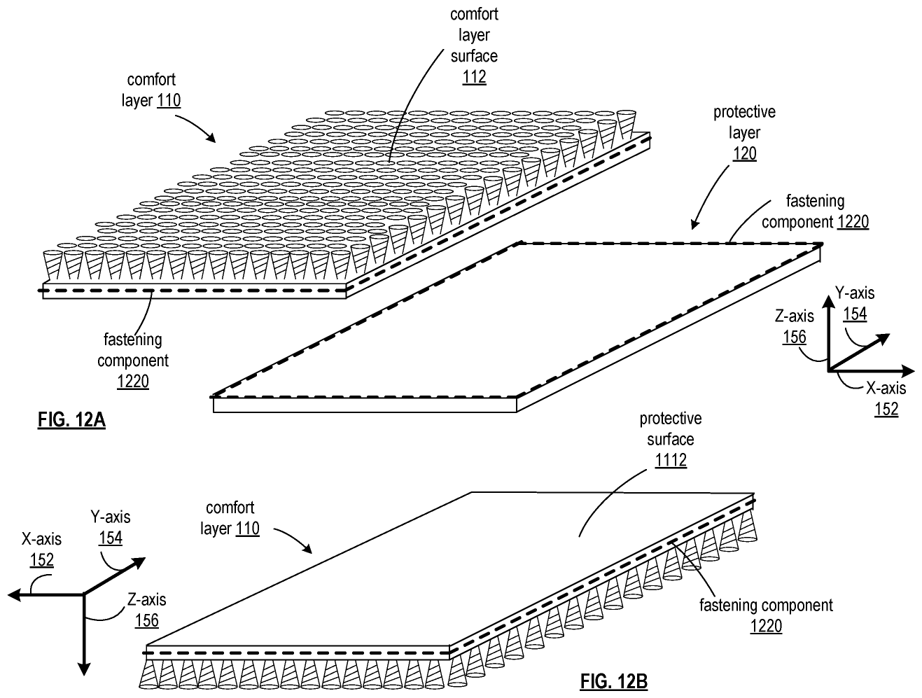

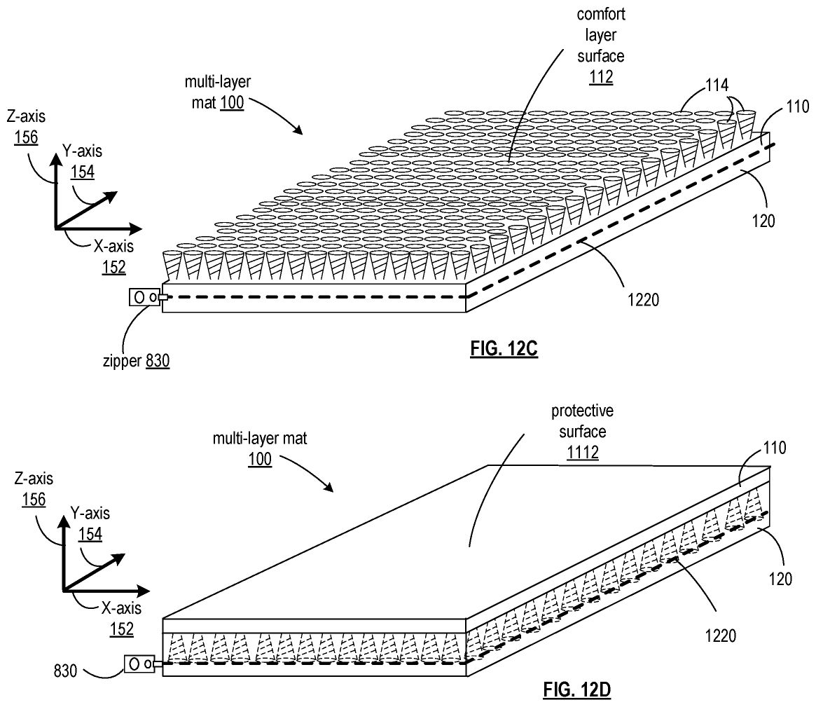

The protective layer 120 and comfort layer 110 can be permanently and/or semi-permanently attached to render the multi-layer mat as a single, fixed unit. The protective layer 120 and comfort layer 110 adhered via stitching, glue, staples, another adhesive component, and/or another mechanism of permanently and/or semi-permanently attaching the layers to each other and/or to additional layers of the multi-layer mat. In some cases, such as in the embodiment presented in FIGS. 12A-12D, the protective layer 120 and comfort layer 110 are instead temporarily attached via a fastening component, where the comfort layer 110 is configured to be easily attached to and removed from the protective layer 120.

Some or all of comfort layer 110 can be made up of a fabric material, textile material, a carpet material, and/or another type of material that is soft and/or plush against bare skin. For example, the comfort layer surface 112 of comfort layer 110 and/or other portions of comfort layer 110 can be composed of a cotton material, a wool material, a fleece material, a polyester material, a nylon material, a jute material, a bamboo material, a silk material, a plush material, a modal material, a terry fabric material, a viscose material, a microfiber material, an olefin material, a blended material, and/or other textile, carpet, and/or fabric.

Comfort layer 110 can include a plurality of fabric fibers 114. The fabric fibers 114 can stand erect from the comfort layer surface 112, parallel to the Z-axis 156 as depicted in FIG. 1. Fabric fibers 114 can be implemented via nap and/or a plurality of piles, such as looped piles, cut piles, warp pile fabrics, point piles, weft piles, knotted piles, or other types of nap and/or piles. In some embodiments, the comfort layer surface 112 are is implemented via a plush fabric, terrycloth fabric or other long-pile fabric, where the long piles of the long-pile fabric implement the fabric fibers 114. In some embodiments, the plurality of fabric fibers 114 can be implemented via a plurality of carpet piles and/or a knotted weave of a carpet material. The plurality of fabric fibers 114 can be sufficiently long and/or fibrous to absorb moisture, such as moisture of a user's feet due to sweat and/or water. The plurality of fabric fibers 114 can be sufficiently long and/or fibrous, grams per square meter (GSM) and/or other fabric weight metric of the comfort layer surface 112 can be sufficiently high, to further provide a soft, and/or fluffy consistency of the comfort layer surface 112. Alternatively, the comfort layer surface 112 is implemented via a short-piled fabric and/or any other woven fabric with any style of weaving. For example, in other embodiments of the multi-layer mat, the fabric fibers 114 do not stand parallel to the Z-axis 156.

FIG. 1 depicts a coordinate system with respect to the multi-layer mat 100 that includes an X-axis 152, Y-axis 154, and Z-axis 156. The coordinate system of FIG. 1 is utilized in other figures presented herein to indicate how other the respective views of various embodiments of the multi-layer mat 100 relate to the view presented in FIG. 1 and/or to other views illustrated herein. Note that other orientations of the multi-layer mat 100 that are not depicted in FIGS. 1-24 are also possible.

FIG. 2 depicts another three-dimensional view of a multi-layer mat 100 where comfort layer surface 112 is not visible, and where a protective layer surface 122 of the protective layer 120 is visible. In particular, the multi-layer mat 100 depicted in FIG. 2 can correspond to the same multi-layer mat 100 of FIG. 1 flipped about the Y-axis 154, as illustrated.

Some or all of protective layer 120 can be made up of a durable material and/or waterproof material such as a durable rubber and/or plastic material capable of withstanding, and/or protecting the comfort layer 110 from, conditions of the ground it is placed upon. This can include enduring and/or protecting the comfort layer 110 from wet conditions of the ground, snowy conditions of the ground, dirty conditions of the ground, sandy conditions of the ground, and/or other conditions of the ground that could damage the comfort layer 110 and/or make the comfort layer 110 less comfortable. In particular, if the multi-layer mat is placed on a wet surface, protective layer 120 can prevent comfort layer 110 from getting wet from the wet surface. The protective layer can be durable enough to withstand, and can protect comfort layer 110 from, damage by gravel, rocks, twigs, and/or sharp components.

Some or all of the protective layer 120 can therefore be made of weather-resistant materials such as a waterproof material, a water-resistant material, a weather-protected material to help ensure the protective layer 120 protects the comfort layer 110 from soaking up moisture from a wet, snowy, icy, or muddy ground. Some or all of the protective layer 120, such as the protective layer surface 122, can have alternatively or additionally have undergone a waterproofing or a water-resisting treatment. Some or all of the protective layer 120, such as the comfort layer surface 112, can alternatively or additionally be made of a durable, abrasion resistant material to help ensure the protective layer 120 can withstand, and protect comfort layer 110 from, sharp rocks, gravel, twigs, and/or uneven surfaces of the ground.

The protective layer 120 can be configured to withstand extreme temperatures that may be induced by ground. Some or all of the protective layer 120, such as the comfort layer surface 112, can be made of a material that has a melting point higher than, and/or can otherwise withstand contact with, hot temperatures of the ground. For example, the protective layer 120 is configures to withstand contact with surfaces up to one-hundred forty degrees Fahrenheit, or another hot temperature characteristic of hot pavement surfaces on summer days, to ensure the protective layer 120 will not melt and/or become damaged when in contact with hot surfaces. This can be ideal in cases where the multi-layer mat 100 is utilized for changing in a parking lot on a hot summer day with pavement that can be heated to these extreme temperatures.

Alternatively or in addition, some or all of the protective layer 120 can be made of a material that will not crack or become damaged when exposed to cold ambient temperatures that may be induced on cold winter days. For example, the protective layer 120 can be configured to withstand ambient temperatures as low as negative sixty degrees Fahrenheit and/or another cold ambient temperature characteristic of use on cold winter days. As another example, the protective layer 120 can configured to withstand contact with snow and/or ice on the surface of the ground.

In some cases, the protective layer 120 of some multi-layer mats 100 is only configured with hot temperatures in mind while the protective layer 120 of other multi-layer mats 100 is only configured with cold temperatures in mind. In such embodiments, different multi-layer mats 100 configured with different temperature ratings can be used by the user in differing temperature conditions and/or times of year. In some embodiments, multiple, removable protective layers 120 of the multi-layer can be rated for different temperatures, different weather conditions, and/or different levels of water-resistance. The user can select one removable protective layers 120 to be temporarily attached to the multi-layer mat 100 via a fastening components based on their selected activity, temperature and/or weather conditions during the selected activity, expected level of precipitation and/or moisture on the ground, and/or the current season of the year. In such cases, different protective layers 120 can be attached based on whether the user is mountain biking and hiking in summer months or skiing in winter months.

Some or all of protective layer 120 can be comprised of a rubber material such as natural rubber, isoprene rubber, synthetic rubber, ethylene propylene diene, nitrile rubber, styrene butadiene rubber, silicone rubber, butyl rubber, and/or polybutadiene rubber. The rubber material can be a non-porous rubber and/or slip-resistant rubber material to aid in preventing the multi-layer mat 100 from sliding against the ground. Some or all of protective layer 120 can include a canvas material or polyester material coated with polyurethane. Some or all of protective layer 120 can be comprised of a plastic material such as polyethylene. Some or all of protective layer 120 can be comprised of a vinyl material and/or a silnylon material.

As illustrated in FIG. 2, the protective layer surface 122 of protective layer 120 can include a plurality of texture elements 124, for example, that protrude from the protective layer surface 122 and/or are indented into the protective layer surface 122 to increase the friction between the multi-layer mat 100 and the ground induced by normal force opposing the downward force induced by the weight of the multi-layer mat 100 itself and/or the additional downwards force exerted by a person standing on the multi-layer mat 100, where this higher friction helps prevent the mat from slipping and/or sliding on the ground. Alternatively, the material utilized for protective layer surface 122 can have a coefficient of friction high enough such that the textured elements 124 are not necessary. In some embodiments, the protective surface can include a plurality of small holes, for example, enabling water or other moisture collected by the user standing upon the multi-layer mat 100, or exposure to weather conditions such as rain or snow, to drip all the way through the mat and onto the ground instead of collecting within the mat. This can be useful in enabling the multi-layer mat to be lighter and/or to mitigate mold and/or mildew by preventing moisture from collecting and setting within the interior of mat.

As illustrated in FIGS. 1-2, the perimeter of the comfort layer surface 112 can align with the perimeter of the protective layer surface 122, where each line connecting two corresponding points of each perimeter are parallel to the Z-axis and/or are otherwise normal to the corresponding portion of the comfort layer surface 112 and the corresponding portion of the protective layer surface 122. While in the usage configuration, the protective layer surface can be included in a first plane and the comfort layer surface can be included in a second plane that is parallel to the first plane. As depicted in FIGS. 1-2, the first plane and second plane can be parallel to the plane defined by the X-axis 152 and Y-axis 154. A segment can be defined by connecting a center point of the protective layer surface and a center point of the comfort layer surface. This segment can be perpendicular to the first plane and the second plane. In this fashion, in the flat, usage configuration depicted in FIGS. 1 and 2, the protective layer surface and comfort layer surface can be considered bases of a right rectangular prism rather than an oblique rectangular prism, where the height of the right rectangular prism is along the Z-axis and is defined by the aggregate thickness of the protective layer 120 and the comfort layer 110.

While the embodiment of multi-layer mat 100 illustrated in FIGS. 1 and 2 depicts a multi-layer mat with rectangular surfaces, other embodiments of multi-layer mat 100 can be circles, squares, ovals, other polygons, or any other shape. Different embodiments of multi-layer mat can be various sizes, for example, based on whether they are configured to accommodate a single person or multiple people. The multi-layer mat 100 can be of a size configured for use by a user to sit or stand on the mat, where the area of the comfort layer surface 112 of comfort layer 110 the mat can have room for or otherwise support up to one user standing or sitting on the mat. Alternatively, other embodiments of multi-layer mat 100 can be of a size configured for use by a user to sit or stand on the mat, for example, where the area of the comfort layer surface 112 of comfort layer 110 the mat can have room for or otherwise support up to two users standing or sitting upon the comfort layer surface 112 simultaneously while not touching each other and/or up to any selected number of users standing or sitting on the mat simultaneously.

As a particular example, a multi-layer mat 100 configured for use by one person can have a width along the X-axis 152 of ranging within roughly one to three feet and can have a length along the Y-axis 154 ranging within roughly two to five feet. More exact dimensions can be based on, for example, the size of the user, the activity the user engages in, and/or desired storage, weight, and/or portability of the multi-layer mat 100. Configuring the area of the multi-layer mat 100 to be small, such as roughly two feet by three feet, while still allowing a single user to step upon it with one or two feet can be useful in enabling the user to easily step on and off the mat. For example, this can be useful in changing of footwear while keeping the comfort layer surface 112 clean. The user can stand on the ground adjacent to the multi-layer mat while in their dirty footwear after completing their activity to keep the comfort layer clean from the dirty footwear. The user can remove the dirty footwear and/or change their footwear, for example, by removing footwear from one foot at a time, by only standing on the comfort layer surface 112 with their unprotected socked foot after the corresponding piece of footwear is removed, and by standing upon the other foot, which still has its corresponding footwear on, directly on the ground and not on the comfort layer surface 112.

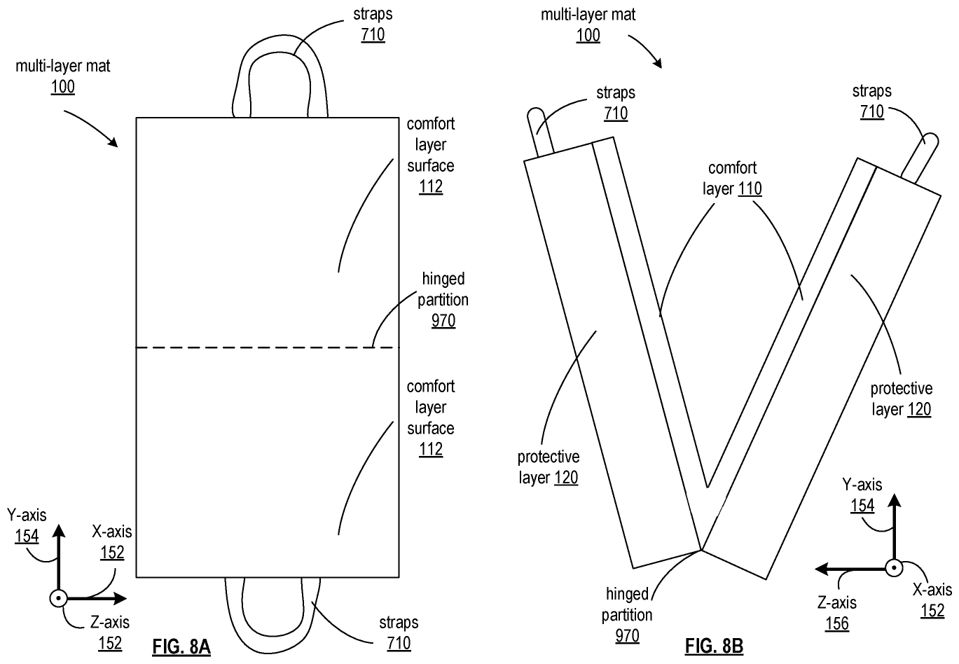

While the embodiment of multi-layer mat 100 illustrated in FIGS. 1 and 2 depicts protective layer 120 and comfort layer 110 having relatively equal thicknesses along the Z-axis 156, other embodiment of multi-layer mat 100 can have protective layers 120 and comfort layers 110 with different thicknesses. For example, the protective layer 120 can be substantially thicker than the comfort layer 110 to best mask the feeling of rocks and/or gravel, and/or to best protect the comfort layer 110 from hot temperatures, sharp rocks and/or moisture. As another example, the comfort layer 110 can be substantially thicker than the protective layer 120, for example, to enable greater ease of folding and/or rolling the multi-layer mat 100 into its storage configuration as discussed in further detail in conjunction with FIGS. 8A-10 based on the comfort layer 110 being more flexible than the protective layer 120, and/or to provide more maximal comfort via an ultra-soft comfort layer. Different multi-layer mats 100 can have differing widths of protective layer 120 and comfort layer 110, for example, based on the types of weather and/or ground conditions the multi-layer mat 100 is expected to endure, for example, based on the corresponding activity in which the user wishes to engage. In some embodiments, the protective layer 120 and comfort layer 110 each have a thickness between a fraction of a millimeter and several inches.

In some cases, a plurality of removable thin layers of the protective layer 120 and/or comfort layer 110 can be selectively applied and attached by the user to dynamically configure the thickness of each layer based on their desired level of ruggedness the multi-layer mat 100 needs to withstand, based on their desired level of comfort, and/or based on their desired level of ease in carrying the multi-layer mat 100 and/or in transitioning the multi-layer mat 100 from a usage configuration to a storage configuration.

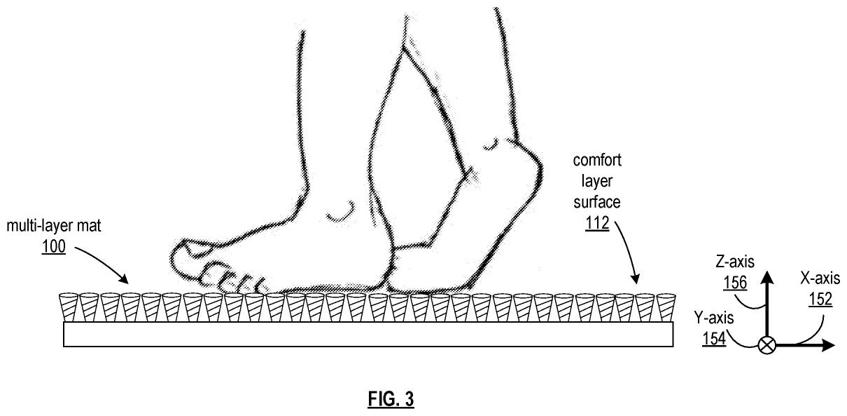

FIG. 3 presents an embodiments of a two-dimensional side view of the multi-layer mat 100, illustrating the use of multi-layer mat 100 by a user when the multi-layer mat 100 is in a usage configuration. As used herein, the “usage configuration” of multi-layer mat 100 corresponds to the configuration where multi-layer mat 100 is laid flat upon the ground for standing upon by one or both feet of one or more users to aid the one or more users in changing their footwear and/or shoes comfortably and safely.

As used herein, an “unprotected foot” refers to a bare foot or a foot protected only by socks, and “unprotected feet” similarly refers to bare feet or feet protected only by socks. As used herein “footwear” refers to shoes, sandals, boots, footwear specific to an athletic and/or outdoor activity, or other footwear with a sole that protects a foot wearing the footwear from ground elements. A foot that is wearing footwear is considered protected and is thus does not constitute an “unprotected foot.”

As illustrated, a user can stand on multi-layer mat with one of both of their unprotected feet at a time. Alternatively or in addition, the user can sit, kneel, and/or squat on the multi-layer mat. The unprotected user's feet and/or other portions of the user's body contact the comfort layer surface 112 of comfort layer 110, offering a luxurious experience for the user while protecting the user's unprotected feet from wetness, sand, dirt, sharp or protruding hazards of the ground, and/or other elements of the ground. The hardness of the protective layer and/or thickness of multi-layer mat 100 can further prevent the user from feeling discomfort of gravel, stones, pebbles, twigs, and/or other objects that cause the ground to be uneven and/or uncomfortable to stand on with unprotected feet. The insulation of protective layer 120 and/or thickness of multi-layer mat 100 can keep the user's unprotected feet protected from the snow and/or ice of the ground in cold weather conditions, and/or can keep the user's feet protected from hot pavement and/or gravel of a parking lot or other ground in hot weather conditions. The fabric fibers of the comfort layer 110, and/or insulation provided by the protective layer or additional layers discussed herein, can further aid in warming the user's unprotected feet in cold weather. The fabric fibers of the comfort layer 110 can further aid in drying the user's unprotected feet if they are wet, sweaty, or dirty after engaging in their activity. For example, the user can slide their unprotected feet along the fabric fibers of the comfort layer surface 112 to whisk away moisture.

In some cases, the multi-layer mat 100 can be alternatively or additionally used for leisurely sitting upon, kneel upon, or laying upon by a user outdoors, where the usage configuration can alternatively or additionally include being sat upon or laid upon by a user. In particular, a user engaging in outdoor activities such as hikes, cross country skiing, or bike rides may wish to take a break, such as at a summit of a hike or on the way to their destination to enjoy the view and/or to eat a snack. In these cases, the user may wish to comfortably sit down for this break. However, no chairs or benches may be present, as the user may be in the wilderness. While the user may seek a flat rock, tree stump, or fallen tree to sit upon, these features are not guaranteed to be available. The user may not be inclined to sit directly on the ground in fear of tearing their pants, dirtying their pants, or causing their pants to become wet if the ground is damp, muddy, or snowy.

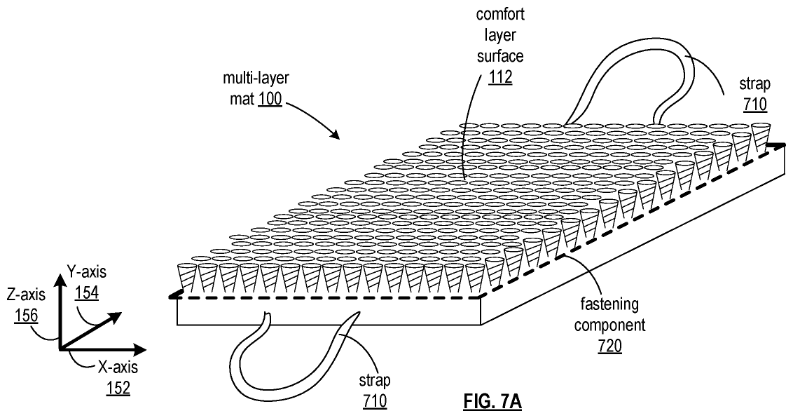

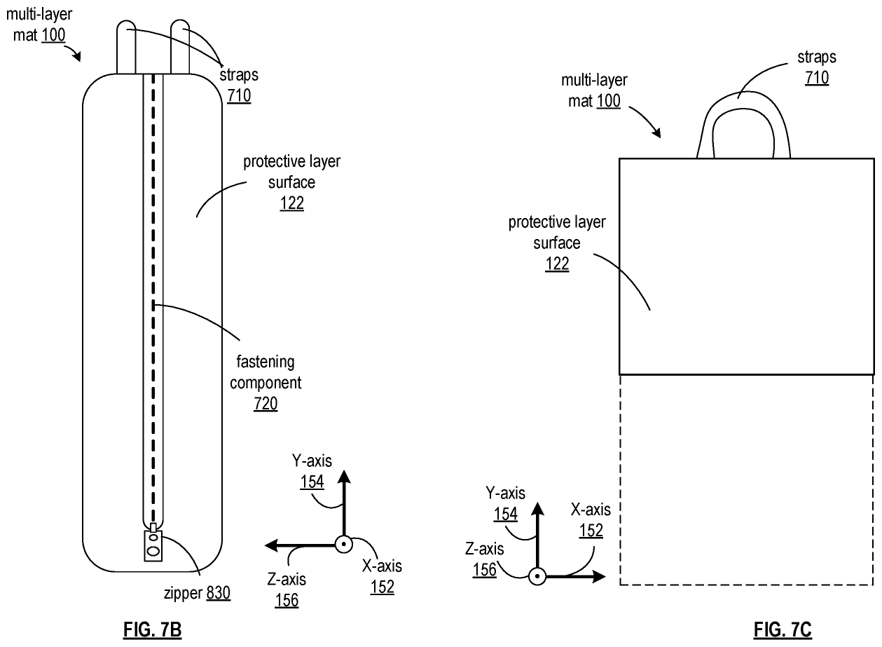

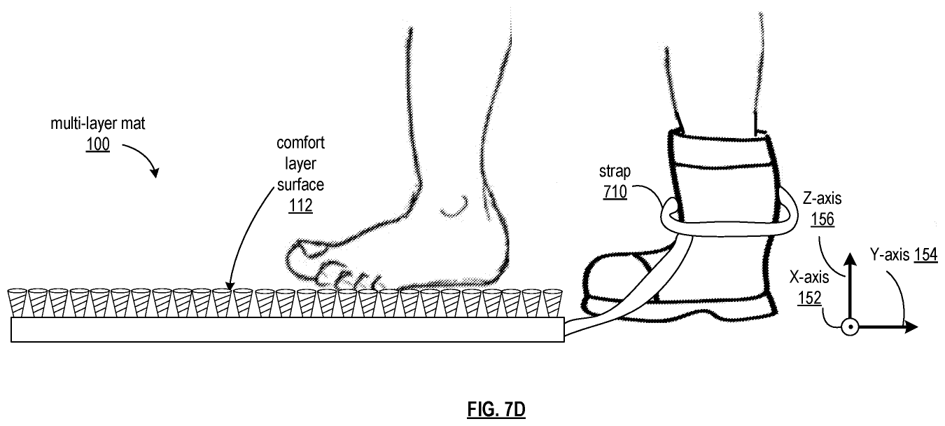

One or more users can utilize multi-layer mat 100 in these cases by laying the mat as illustrated in FIG. 3, and by sitting upon, kneeling upon, or laying upon the multi-layer mat 100. The comfort layer 110 can provide comfort to the user in these positions by a soft and luxurious surface to be sat upon, kneeled upon, or laid upon, and the protective layer can protect the user from feeling sharpness and/or wetness of the ground elements. Furthermore, the storage configuration of the multi-layer mat 100, discussed in further detail in conjunction with FIGS. 7A-12B, can enable the multi-layer mat 100 to be carried by the user during the hike and/or bike ride for use at these leisurely stops and/or break points, while protecting the comfort layer 110.

In various embodiments, a multi-layer mat 100 includes a protective layer and a comfort layer. The protective layer is composed of a first material and has a protective layer surface. The comfort layer is composed of a second material that includes a plurality of fabric fibers and that is distinct from the first material. In various embodiments, the first material includes a non-porous rubber material, a water-resistant plastic material, and/or a waterproof plastic material. In various embodiments, the plurality of fabric fibers is implemented as a plurality of carpet piles and/or other fabric piles.

The comfort layer is attached and/or otherwise positioned on top of the protective layer, for example, with respect to the Z-axis 156. The comfort layer has a comfort layer surface parallel to the protective layer surface, for example, where the comfort layer surface and the protective layer surface are parallel to the plane defined by the X-axis 152 and the Y-axis 154.

In various embodiments, the multi-layer mat 100 is configured to assume a usage configuration and a storage configuration, where the multi-layer mat 100 is configured for manual transition between the usage configuration and a storage configuration via a user. In the usage configuration of the multi-layer mat 100, the multi-layer mat lies flat upon a planar ground surface with the protective layer surface flush against the planar ground surface and with the comfort layer surface exposed for standing upon by at least one foot of a user of the multi-layer mat. For example, the planar ground surface is located outdoors and/or is surfaced with outdoor elements such as grass, dirt, rocks, water, snow, ice, mud, twigs, debris, and/or other outdoor elements. The protective layer is configured to protect the user's unprotected feet and/or the comfort layer from elements of the planar ground surface in the usage configuration via the first material. The comfort layer is configured to provide comfort to the user's unprotected feet in the usage configuration via the second material and/or to remove moisture from the at least one unprotected foot while in the usage configuration via the second material. In the storage configuration, the comfort layer surface can be unexposed and/or partially unexposed to further protect the comfort layer. The storage configuration can otherwise be a different configuration from the usage configuration that is, for example, more practical for storage and/or transport of the multi-layer mat.

In various embodiments, the usage configuration of the multi-layer mat, the protective layer surface is included in a first plane and the comfort layer surface is included in a second plane parallel to the first plane, and wherein a segment between a center of the protective layer surface and a center of the comfort layer surface is perpendicular to the first plane and the second plane.

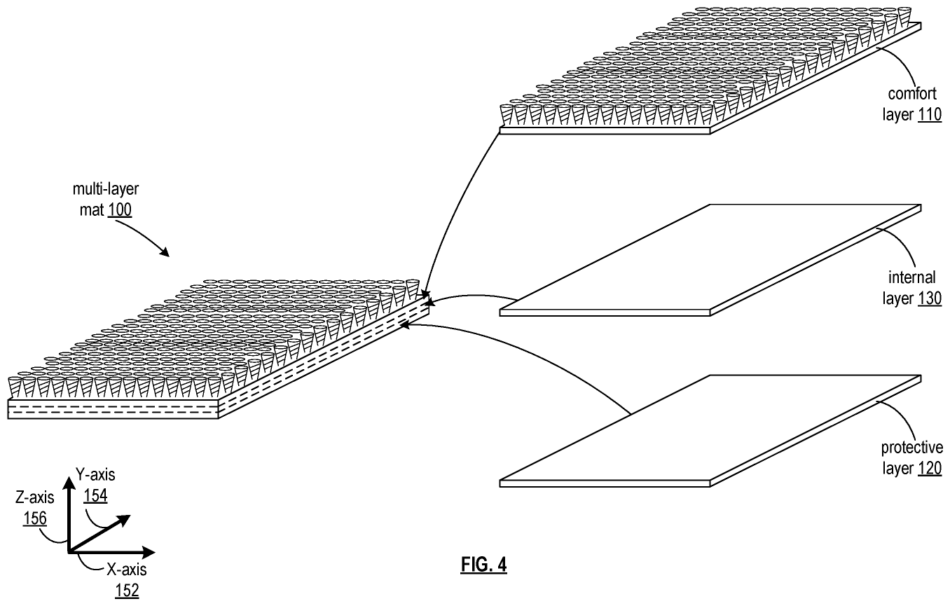

FIG. 4 illustrates a further embodiment of the multi-layer mat of FIG. 1. FIG. 4 illustrates how the multi-layer mat 100 can be comprised of many layers, such as on or more internal layers 130 that are between the comfort layer 110 and the protective layer 120. Internal layers 130 can include one or more cushion layers, which can include memory foam elements or other foam elements, microbeads, down feather elements, and/or other elements that provide additional comfort to a user while standing or sitting on the mat and/or that otherwise correspond to soft materials when tested for hardness via a durometer test.

In some cases, the internal layers 130 can include an inflatable element that is, for example, self-inflating and/or can be inflated via an electric and/or manual pump or via the user's breath. In such embodiments, transitioning from a storage configuration to the usage configuration can include inflating the inflatable element of one or more internal layers 130, and transitioning from the usage configuration back to the storage configuration can include deflating the inflatable element of one or more internal layers 130.

Alternatively or in addition, internal layers 130 can include an insulating layer that protects the comfort layer 110 from coldness of the ground and/or generates heat to the comfort layer 110. For example, the internal layers 130 can include a reflective layer that reflects light from the sun to further warm the user's feet. Alternatively or additionally, the insulating layer can protect the comfort layer 110 from heat generated by the ground such as parking lot pavement in hot climates, for example, where standing on the ground directly is dangerously warm for contact with the skin of a user. Some or all of these internal layers 130 can alternatively be integrated within and/or can replace the comfort layer 110 and/or the protective layer 120.

The internal layers 130 can include a heating element such as heating coils and/or other heating element that is powered via electricity provided by a battery connected to and/or embedded within an internal layer 130 of multi-layer mat 100. The battery can be charged via a wall outlet and/or a power outlet of the car such as a cigarette outlet. For example, a side of the multi-layer mat 100 can include a power interface for a wired and/or wireless connection to AV and/or DC power provided by a battery, wall outlet, car outlet, and/or other power source. Alternatively, a wired connection to the heating element can be facilitated from the power outlet of the car to deliver power to the heating element of the multi-layer mat 100 only when connected to the car. The heating element can be surrounded by additional insulating layers and/or elements, to ensure the heating element does not burn the user and does not damage the protective layer 120 and/or the comfort layer 110. More detailed embodiments of a multi-layer mat 100 that includes a heating element are discussed in further detail in conjunction with FIGS. 18A-24.

In various embodiments, the multi-layer mat 100 includes at least one internal layer between the comfort layer and the protective layer. In various embodiments, the at least one internal layer includes at least one foam element, a plurality of microbeads, a plurality of down feather elements, and/or at least one inflatable element. In various embodiments, the at least one internal layer includes at least one heating element configured to warm the at least one foot of the user in the usage configuration.

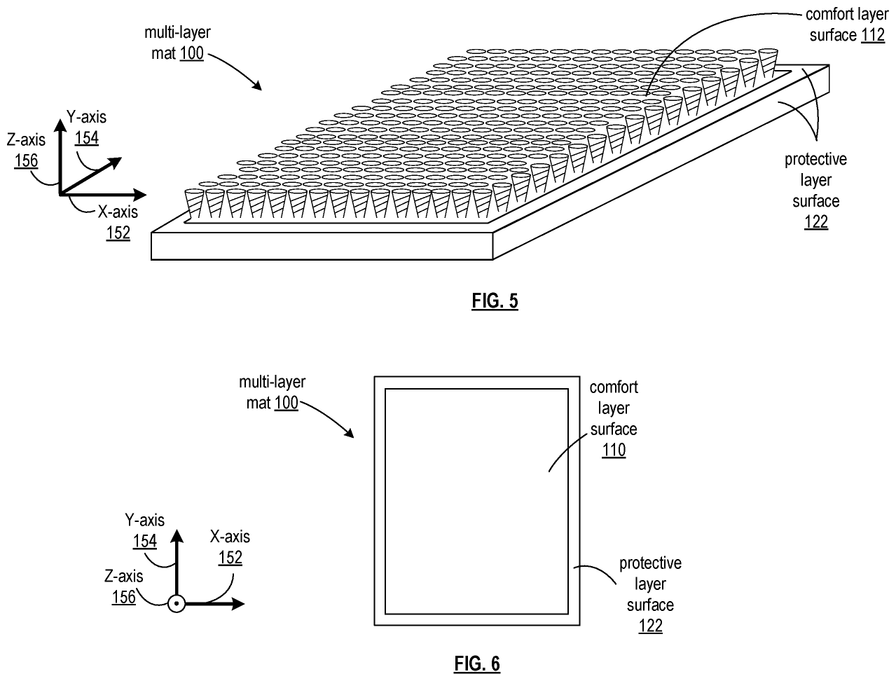

FIGS. 5 and 6 illustrate another example embodiment of the multi-layer mat 100 of FIG. 1. The protective layer surface 122 can extend to further surround the sides and/or to border the comfort layer 110 on the top of the mat, for example, to protect the sides of the mat and the comfort layer surface 112 comfort layer 110 from damage and/or dirtying from the ground and/or natural elements that may interact with the sides and/or top of the mat. FIG. 5 presents such an embodiment in a three dimensional view of the multi-layer mat, which can be the same view as illustrated in FIG. 1. FIG. 6 presents this embodiment from a two-dimensional top view of the mat. The additional protection via extension of protective layer surface 122 depicted in FIGS. 5-6 can be applied to the multi-layer mat 100 of FIG. 1 instead of or in addition to one or more other features of multi-layer mat 100 presented in any other embodiments of multi-layer mat 100 described herein.

FIGS. 7A-12D are example embodiments of the multi-layer mat 100 of FIG. 1 that further introduce additional features to enable storage and/or transport of the multi-layer mat. In particular, the user may wish to be able to easily carry the multi-layer mat 100 to and from their car. In some embodiments, the user may wish to carry that multi-layer mat further distances, such as to a campsite or to a beach. Furthermore, the user may wish to store the mat in a storage configuration that takes up less space in storage in a car or closet of the user.

As used herein, the “storage configuration” of the multi-layer mat 100 corresponds to a secured configuration of the multi-layer mat 100 for storage and/or for transport. The “storage configuration” can be interchangeably referred to as a “transport configuration.” The storage configurations illustrated and discussed herein can be utilized to enable easy and/or practical storage or transport of the multi-layer mat. The storage configurations illustrated and discussed herein can be further utilized to protect the comfort layer from dirtying and/or damage when the multi-layer mat is not in use by keeping the comfort layer unexposed and/or partially unexposed. One or more of the mechanisms utilized to enable the storage configuration of multi-layer mat 100 depicted in FIGS. 7A-12B and described herein can be applied to the multi-layer mat 100 of FIG. 1 instead of or in addition to one or more other features of multi-layer mat 100 presented in any other embodiments of multi-layer mat 100 described herein.

The storage configuration can include a rolled-up and/or folded configuration of the multi-layer mat 100. This can be different from the usage configuration illustrated in FIGS. 1-6, where the multi-layer mat 100 is configured to lie flat in the usage configuration. In some cases, the comfort layer 110, protective layer 120, and/or internal layers 130 can be made of a flexible material that enables the multi-layer mat 100 to be rolled up and/or folded.

In some embodiments, the multi-layer mat 100 can remain rolled up and/or folded without additional fastening or securing, where the rolled up and/or folded multi-layer mat 100 is an equilibrium state for components of the multi-layer mat and where the multi-layer mat will thus remain in its rolled up and/or folded configuration until unrolled and/or unfolded by the user. Alternatively, fastening mechanisms such as straps, buttons, snaps, ties, magnets, and or a separate sleeve configured to secure the mat in its storage configuration can be utilized to ensure the multi-layer mat 100 remains in its storage configuration. This can be necessary if the comfort layer 110, protective layer 120, and/or internal layers 130 are made of materials where the only equilibrium state is lying flat, and where additional fastening is required to secure the multi-layer mat 100 to maintain the storage configuration.

As illustrated in FIG. 7A, the multi-layer mat 100 can include one or more straps 710, which can include flexible and/or rigid straps, handles, or other mechanisms that allow the user to carry the multi-layer mat with their hands, over their shoulder, and/or on their back. In some embodiments, straps 710 can be configured to attach to a bike, other sporting equipment, and/or transportation equipment utilized by the user while engaging in the activity and/or while transporting to and/or from the location of the activity. For example, these straps can be useful in transporting the multi-layer mat from the user's vehicle to a trail head and/or campsite for use in changing footwear and/or clothing. As another example, these straps can be utilized by the user for easy transport of the multi-layer mat during a trek of a hike, cross country skiing, and/or bike ride for sitting upon during one or more stops or break points of the trek, as discussed previously. In some embodiments, the one or more straps 710 are configured for carrying of the multi-layer mat 100 while in its storage configuration, for example, where the multi-layer mat is folded and/or rolled to be carried via straps 710.

These straps 710 can be made of a flexible or rigid material. While FIG. 7A portrays the straps being attached to the sides of the multi-layer mat, the straps can alternatively be attached to another portion of the mat such as the protective layer surface 122 or comfort layer surface 112. In some embodiments, a portion of the straps can be integrated within an internal layer 130 to further secure the straps to the mat, for example, where ends of the straps are pressed and/or secured between the comfort layer 110 and the protective layer 120. In some embodiments, the straps are removable. In such embodiments, the straps can include a rope, string, fabric, ribbon, or other flexible mechanism that can be tied to and/or can loop through holes and/or slots of the multi-layer mat. The multi-layer mat can include a plurality of such slots in different locations along the perimeter of the multi-layer mat to allow the user to configure a custom configuration of folding, rolling, and/or carrying the mat.

The multi-layer mat 100 of FIG. 7A can alternatively or additionally include a fastening component 720. Fastening component 720 can be implemented via a zipper fastener, a one or more buttons, a one or more snaps, a one or more ties, one or more hook and loop mechanisms such as Velcro, one or more magnets, and/or another fastener utilized to temporarily fasten and/or unfasten the mat into and out of its storage configuration. Any properties, features, and/or functionality of fastening component 720 can be utilized to implement any other fastening components described herein.

While the fastening component 720 is depicted to be connected along the sides of the multi-layer mat 100, the fastening component 720 can be integrated into any surfaces of the multi-layer mat 100 such as the comfort layer surface 112, the protective layer surface 122, and/or one or more sides along the Z-axis 156. The fastening component 720 can optionally extend from the surfaces of the multi-layer mat 100 via one or more straps or other appendages of the multi-layer mat 100. The fastening component 720 can be integrated within and/or between one or more layers of the multi-layer mat 100. The fastening component 720 can otherwise be attached in any configuration to enable securing of the multi-layer mat in its storage configuration via fastening, and to enable transition from the storage configuration to the usage configuration via unfastening. In some cases, no fastening component 720 is utilized, where gravitational forces and/or properties of the materials are sufficient in securing of the multi-layer mat in its storage configuration.

In some cases, when a hook and loop mechanism is utilized by fastening component 720 and/or any other fastening components utilized herein, some or all of the fabric fibers 114 of the comfort layer 110 can be implemented as loops of a hook and loop fastener. In particular, in cases where the fabric fibers 114 are implemented via a plurality of looped piles, these looped piles can be fastened to hooks of the hook and loop fastener. This enables dual functionality of the comfortable fabric fibers by also integrating these fabric fibers into the fastening component, where integrating an additional fastening into the multi-layer mat is not necessary, and only a hook fastener need be integrated into multi-layer mat 100 and/or into a separate strap or other fastener. In these cases, the hooks of the fastening component are thus configured to secure to some or all of the fabric fibers 114 of the comfort layer 110.

As shown in FIG. 7B, the fastening component 720 can be utilized to secure the multi-layer mat 100 in a storage configuration where the mat is folded in half, and where only the protective layer surface 122 of the protective layer 120 is exposed on the outside. For example, two sides of a zipper fastener can form a perimeter around the entirety of the sides of the multi-layer mat 100 in its lying flat configuration as illustrated in FIG. 7. The zippers can be utilized to entirely secure the multi-layer mat 100 in half via a zipper mechanism 830 as shown in FIG. 7B, enabling easy transport of the multi-layer mat 100 while enclosing and protecting the comfort layer surface 112 of the comfort layer 110. As illustrated in FIG. 7B, the two straps 710 can be utilized to carry the multi-layer mat 100 while in its storage configuration, for example, where the straps 710 meet in the middle once the multi-layer mat is folded in half, enabling both of straps 710 to be held simultaneously in a single hand of the user and/or be supported by one or both shoulders of the user for carrying. This can correspond to the same two-dimensional side view of FIG. 3, after the mat is converted to the folded storage configuration. FIG. 7C illustrates a two-dimensional top view of this storage configuration of FIG. 7B, which can correspond to the same top view as illustrated in FIG. 6 once the mat has been converted to the storage configuration.

In other embodiments of the multi-layer mat 100, no additional fastening component 720 is included. However, the multi-layer mat can similarly be folded along the same axis as illustrated in FIG. 7B such that both straps 710 depicted in FIGS. 7A-7B meet in the middle, enabling a user to transport the multi-layer mat 100 by carrying by both straps 710 in one hand. This folding for transport via straps 710 can constitute transitioning to the storage configuration.

FIG. 7B depicts the multi-layer mat to have its comfort layer surface 112 fully unexposed with the entirety of comfort layer surface 112 on one half of the fold laying flush to the comfort layer surface 112 on the other half of the fold. However, in other embodiments, such as embodiments where additional fastening component 720 is included, some portions of the comfort layer surface 112 may not lay flush to their counterparts on the other half and thus may not be entirely unexposed. For example, a perfect fold may not be possible due to thickness or rigidness of material used to implement one or more layers of the multi-layer mat 100, and portions of the comfort layer surface 112 on one half of the fold may not touch their mirrored counterparts of the comfort layer surface 112 on the other half, rendering the comfort layer surface 112 only partially unexposed. In some cases the multi-layer mat 100 is particularly rigid, no portions of the comfort layer surface 112 may be capably of laying flush to other portions of the comfort layer surface 112 after the fold in this storage configuration. However, the comfort layer surface 112 can still be considered unexposed and/or partially unexposed in this case, as the folded configuration still protects the multi-layer mat 100 from the outdoor elements, for example providing more protection and reducing the comfort layer surface 112's exposure to outdoor elements more than if the mat remained flat and unfolded.

As discussed with regards to the storage configuration herein, the multi-layer mat can still be considered to assume a storage configuration even if comfort layer surface 112 is not entirely unexposed. In this case, the multi-layer mat 100 can still assume a more convenient folded configuration for transport that is distinct from laying flat upon the ground, where a user can hold both straps 710 depicted in FIGS. 7A and 7B in one hand to render the comfort layer surface 112 as partially unexposed and to enable more convenient carrying of the multi-layer mat 100, this constitutes a storage configuration of the multi-layer mat 100. Similarly, any other configurations of multi-layer mat 100, where the comfort layer surface 112 is similarly partially unexposed and the multi-layer mat 100 is in a different configuration from the usage configuration for more convenient carrying, transport, and/or storage, can all be implemented as additional embodiments of the storage configuration.

FIG. 7D illustrates an embodiment where the same or different strap 710 of FIGS. 7A-7C is configured to secure to a boot of the user. This can be useful in cases where outdoor conditions such as wind make the multi-layer mat 100 susceptible to being flipped over or blown away. The strap 710 can loop around a boot, ankle, or footwear of the user as illustrated. As the user may be only changing one piece of footwear at a time, the user can step onto the multi-layer mat 100 with one foot for changing into footwear while the other foot steps onto the ground while secured to the strap 710. In such cases, the strap can be made of an elastic material and/or can have an adjustable radius to enable the strap to secure to boots or ankles of different widths and/or to be slid or secured around the boot and/or ankle.

As illustrated, strap 710 can be configured to serve two distinct functionalities. When the multi-layer mat 100 is in the usage configuration, the strap 710 is utilized to secure the multi-layer mat to the user and/or to another fixed structure to help ensure the multi-layer mat 100 does not blow away, for example, when the user's other foot is lifted to add or remove a sock and/or when the user's other foot is placed off the mat and into footwear. When the multi-layer mat 100 is in the storage configuration, the strap 710 is utilized to secure the multi-layer mat 100 in the storage configuration and/or is utilized to allow the user to carry the multi-layer mat 100 in its storage configuration.

The strap 710 can alternatively or additionally include a clip or hook configured to secure to shoelaces of hiking boots, shoes, or snow boots and/or to secure to buckles of ski boots or snowboarding boots. Alternatively, the user can step upon the strap 710 and/or loop the strap around the insole of their boot while standing to secure the multi-layer mat 100. The strap 710 can alternatively or additionally be configured to secure to other fixed structures that may be conveniently close, such as a car tire or tailgate hitch of the user's car if the user is in a parking lot, to a nearby tree and/or sign post, or to another fixed structure. For example, the loop of strap 710 can open and/or otherwise be detachable via a snap, button, buckle, hook and loop element, or other fastening mechanism to allow the user to loop the strap 710 around a fixed structure that cannot be lifted and/or that the loop of strap 710 cannot be slid or looped around without detaching.

In some embodiments, the multi-layer mat 100 can include a plurality of adjacent panels that are each rigid or semi-rigid. The panels can be connected by flexible material in one or more of the layers of the mat, enabling the multi-layer mat to be rolled and/or folded along these connections, for example, in an accordion folding fashion, and enabling the panels themselves to remain rigid or semi-rigid in the folded and/or rolled configuration. These connections between rigid panels can correspond to locations that the mat is intended to be folded, for example, where the mat is split into two rigid panels to be folded in half.

An example of such an embodiment is illustrated in FIGS. 8A-8B. FIG. 8A illustrates a top view of multi-layer mat 100. Two or more panels of the multi-layer mat 100 can be folded via a hinged partition 970 of the protective layer 120, the comfort layer 110, and/or any internal layers 130. For example, the hinged partition 970 dividing two halves of the multi-layer mat 100 is utilized to enable the folded storage configuration of FIGS. 7A-7C.

FIG. 8B illustrates a side view of multi-layer mat 100 while transitioning to the storage configuration, for example, as depicted in FIG. 7A. Note that in this embodiment, the hinged partition 970 is utilized for rigid or semi-rigid panels of the protective layer 120, for example, based on the protective layer 120 being especially thick and/or durable. The comfort layer 110 can fold naturally as depicted in FIG. 8B, for example, based on the comfort layer being less rigid.

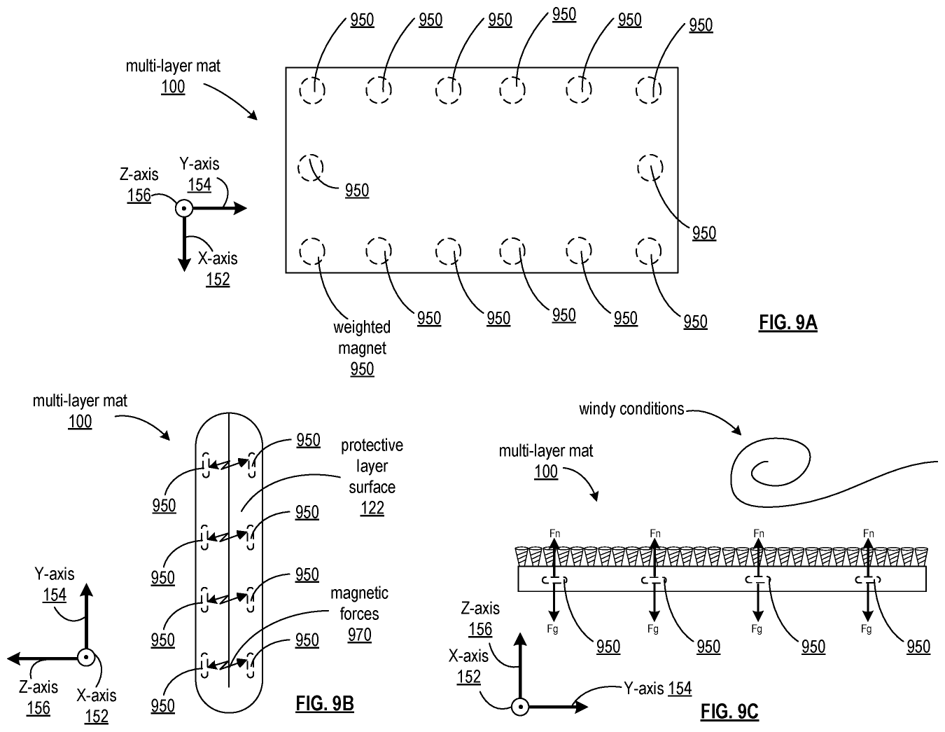

FIGS. 9A-9C illustrate an embodiment of multi-layer mat 100 that utilizes a plurality of weighted fastening elements to implement the fastening component 720 of FIG. 7A. While the example embodiment of FIGS. 9a-9C illustrate these weighted fastening elements as a plurality of weighted magnets 950, other weighted fastening elements such as hooks, straps, or buttons that are made of a dense metallic material and/or that are otherwise heavy can be utilized instead of or in addition to the plurality of weighted magnets 950. As used herein, the “weighted fastening elements” are configured to have a mass and/or density enabling them to induce additional, substantial weight to the multi-layer mat 100 and/or to induce additional, substantial weight friction to the multi-layer mat 100.

While any fastening element has some inherent mass, the weighted fastening elements are specifically configured and/or otherwise selected to provide a significant proportion of the total mass of the multi-layer mat, such as greater than 10% of the total mass of the multi-layer mat. For example, these weighted fastening elements provide enough additional weight to help ensure the multi-layer mat 100 does not blow away or flip over in windy conditions or other conditions that would otherwise cause the multi-layer mat to blow away or flip over. Such an embodiment is contrary to other embodiments where fastening components are selected to have a lighter material such as fabric or plastic, for example to make the multi-layer mat 100 more convenient to carry and/or less expensive to manufacture.

However, in embodiments where the multi-layer mat 100 is to be utilized in windy conditions, the additional expense and/or weight during transport can be ideal in configuring the multi-layer mat 100 to have heavier weighted fastening elements to mitigate chances of the multi-layer mat blowing away or being flipped over when in the usage configuration. In particular, as the user may not always be standing upon or otherwise applying their own weight to the multi-layer mat 100 in the usage configuration, for example, to fetch footwear or other belongings from the car, to alternate between feet, to apply or remove sock, etc., the multi-layer mat 100 can be susceptible to blowing away or flipping over due to wind if it is too light. While utilizing denser materials or applying thicker layers to the comfort layer 110 and/or protective layer 120 may alleviate this problem, this can result in the multi-layer mat 100 being difficult to fold and/or roll into its storage configuration. It can be more advantageous to instead distribute several small, dense elements within the multi-layer mat 100. While such weighted elements can serve purely to provide additional gravitational forces while in the usage configuration in some embodiments, the embodiment of FIGS. 9A-9C illustrate how the fastening components 720 can be exploited to dually enable additional weighting by selecting types of fastening components 720 and/or materials to implement fastening components 720 that may be heavier than necessary for the sole purpose of fastening the multi-layer mat, but are ideal in also providing this additional weight.

As illustrated in the top view of FIG. 9A, a plurality of weighted magnets 950 or other weighted fastening elements can be included along the perimeter of multi-layer mat 100. For example, plurality of weighted magnets 950 are included in an internal layer 130 of the multi-layer mat, and/or are be sewn in one or more pockets and/or are adhered or otherwise secured within and/or between the comfort layer 110 and the protective layer 120. Note that the plurality of weighted magnets 950 can alternatively or additionally be dispersed in interior portions of the multi-layer mat 100 with respect to the X-axis 152 and Y-axis 154 rather than being placed exclusively along the perimeter portions of the multi-layer mat 100. These weighted fastening elements can provide a sufficient supplemental weight as described above to help ensure multi-layer mat does not blow away or flip over.

The plurality of weighted magnets 950 can be spaced such that, when the mat is folded in half as illustrated in FIG. 9B or into another storage configuration, pairs of magnets on opposite sides of the mat align along the perimeter to secure the mat closed in the storage configuration via magnetic forces attracting each pair of magnets. For example, the view of FIG. 9B can correspond to a particular example embodiment of the multi-layer mat 100 as depicted in FIG. 7B where the plurality of weighted magnets 950 are utilized to implement the fastening component 720, for example, instead of or in addition to the depicted zipper 830 and corresponding zipper elements. Note that other heavy fastening components that work in pairs, such as buttons, hooks, or snaps can similarly be spaced on multi-layer mat to align when folded and/or rolled into the storage configuration. As depicted in FIG. 9C, when the mat is in the usage configuration flat upon the ground, the weighted magnets provide additional gravitational forces to help secure the mat to the ground to help prevent the mat from blowing away or being flipped over in windy conditions. This induces greater normal forces to increase the static frictional forces to help keep the multi-layer mat 100 secured in place while in the usage configuration.

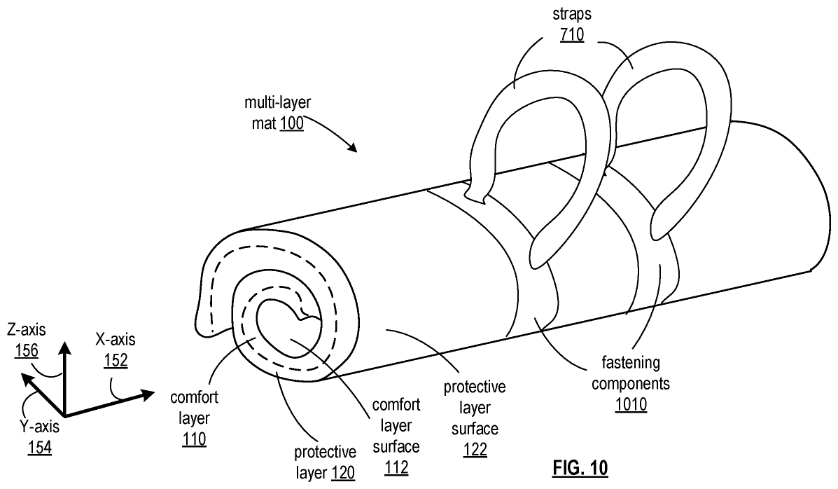

As illustrated in FIG. 10, the multi-layer mat 100 can alternatively or additionally be configured to roll up into the storage configuration. Again, the comfort layer surface 112 of the comfort layer 110 can be entirely unexposed while stored and/or transported in this configuration for protection, where the outside of the rolled up configuration corresponds to the protective layer surface 122. One or more separate fastening components 1010 such as straps, ties, or other fasteners configured to wrap around the multi-layer mat while in the rolled-up configuration in a secure fashion. Fastening components 1010 can be attached to multi-layer mat 100 or separate from the multi-layer mat 100. The same or different straps 710 can be secured to the multi-layer mat 100 itself and/or can be secured to the fastening components 1010, similarly enabling the user to carry the multi-layer mat 100 in their hand, on their back, or over a shoulder while in the rolled-up storage and/or transport configuration. The fastening components 1010 can be implemented via some or all of the features of various fastening mechanisms discussed previously in conjunction with fastening component 720.

In various embodiments, storage configuration of multi-layer mat 100 includes a folded configuration wherein the protective layer surface is exposed and wherein one portion of the comfort layer surface lies flush to a second portion of the comfort layer surface, and/or a rolled configuration wherein the protective layer surface is exposed as an outer surface of the rolled configuration.

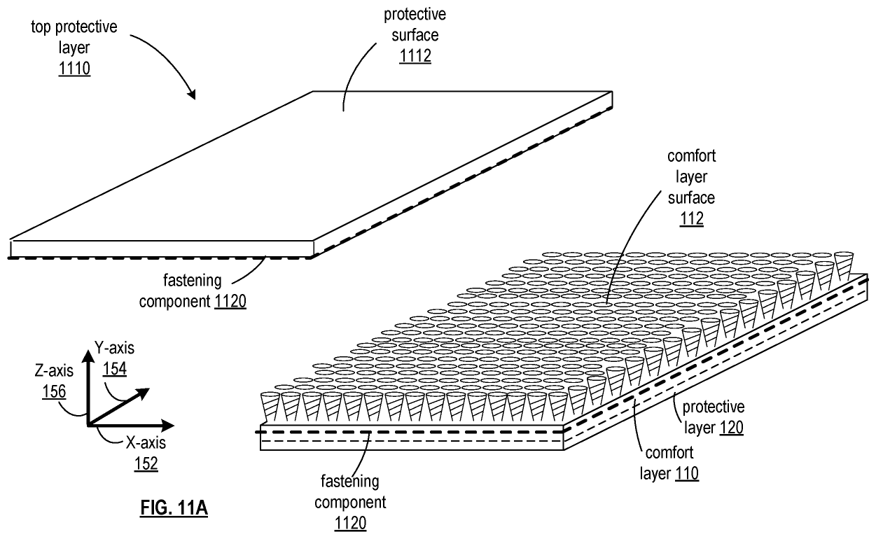

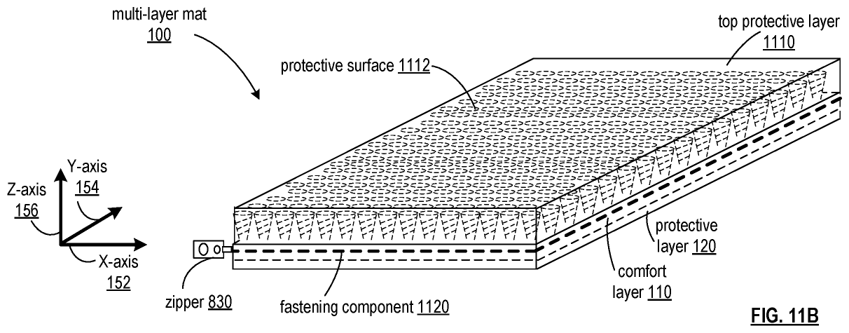

FIGS. 11A-11B illustrate embodiments of a multi-layer mat 100 that assumes its storage configuration when the user secures a protective, removable layer to the multi-layer mat 100 to protect the comfort layer surface 112. In some embodiments, a protective, removable layer, for example, with a weather-protected material of the same or different type as the protective layer surface 122, can be zippered to and/or connected along the outside of the comfort layer 110 via a fastening component 1120 along the perimeter of the comfort surface.

As illustrated in FIG. 11A, a top protective layer 1110 can be separated from the rest of multi-layer mat 100 when multi-layer mat 100 is in the usage configuration. As illustrated in FIG. 11B, the top protective layer 1110 can be attached to the multi-layer mat 100 to transition the multi-layer mat 100 from the usage configuration to the storage configuration by protecting the comfort layer surface 112.

The top protective layer 1110 can have an exposed protective surface 1112 that can be made of a waterproof material, a water resistant material, an abrasion resistant material, and/or any other protective material as discussed previously in conjunction with the various embodiments of the protective layer 120. In some cases, the top protective layer 1110 is substantially thinner and/or more flexible than the protective layer 120. For example, the top protective layer 1110 can be made of a light and/or flexible canvas material and/or fabric material, while the protective layer 120 can be made of a more rigid and/or more durable rubber material. As a particular example, the top protective layer 1110 can be comprised of materials such as nylon, polyester, rayon, cotton, vinyl, and/or other fabrics.

The top protective layer 1110 can be attached and detached from the multi-layer mat via one or more fastening components 1120, which can utilize zipper fastener, a one or more buttons, a one or more snaps, a one or more ties, one or more hook and loop mechanisms, one or more magnets, and/or another fastener utilized to temporarily fasten and/or unfasten. For example, the fastening component 1120, can be implemented by utilizing fastening components 720 and/or 1010. The removable top protective layer 1110 of FIGS. 11A-11B can be applied to transition the mat from its usage configuration to its storage configuration instead of or in addition to the rolling and/or folding of the multi-layer mat 100 as discussed previously in conjunction with FIGS. 7A-10.

While the fastening component 1120 is depicted about the perimeter of the comfort layer surface 112, the fastening component can be included in more central portions of the mat. For example, a plurality of magnets, such as weighted magnets 950 of FIGS. 9A-9C, can be enclosed, attached, and/or secured upon or under the comfort layer 110 and can also be enclosed, attached, and/or secured upon or under the comfort layer 110, and the top protective layer 1110 can be secured to the multi-layer mat via the a plurality of magnets. As another example, a hook and loop fastener can be utilized to secure the top protective layer 1110 can be secured to the multi-layer mat. In particular, an underside of the top protective layer 1110 can include hooks of the hook and loop fastener, and some or all of the fabric fibers of the comfort layer can be implemented as loops of the hook and loop fastener. This can be ideal in enabling dual functionality of the comfortable fabric fibers by also implementing the fabric fibers as loops of a hook and loop fastener.

In some cases, the application of top protective layer 1110 can also enhance usage of multi-layer mat 100. For example, a second usage configuration can be assumed by flipping the multi-layer mat 100 about the Y-axis 154, for example, once the top protective layer 1110 is attached. Thus, in the second usage configuration, the protective surface 1112 is flush against the ground, and the top protective layer 1110 protects the comfort layer surface 112 from the wetness and/or dirtiness of the ground. The protective layer surface 122 is exposed, allowing the user to step upon the protective layer surface 122 with one or both feet. In particular, the protective layer surface 122 can be utilized by the user in this second usage configuration to allowing the user to stand upon the protective layer surface 122 to scrape mud, dirt, sand and/or snow off of their footwear utilizing textured elements 124, for example, after engaging in an outdoor activity in this footwear and before removing their footwear. The user can then flip the multi-layer mat 100 back over to assume the usage configuration illustrated in FIGS. 1 and 3, and can unzip, unfasten, or otherwise remove the top protective layer 1110 to expose the comfort layer surface 112. The user can remove their footwear, and can stand upon the still-clean comfort layer surface 112 in their unprotected feet as illustrated in FIG. 3 and discussed previously.

As another example of how top protective layer 1110 enhances usage of multi-layer mat 100, a third usage configuration of multi-layer mat 100 can alternatively or additionally be implemented. In some cases, the third usage configuration can be assumed by applying the top protective layer 1110 and laying the multi-layer mat flush against the ground with the top protective layer 1110. The user stands upon the protective surface 1112, for example, with their unprotected feet, where the protective layer is flush against the ground. This can be ideal in cases where it is rainy or snowy outside, or when the user's feet are particularly dirty, and the user wishes to protect the comfort layer 120 from damage, dirtying, or becoming soaked. This can still be a comfortable usage configuration for the user, for example, in embodiments where the protective surface 1112 is made of a thin and/or flexible material such as a canvas or fabric material that is water resistant, water proof, or abrasion resistant. In such cases, while the user's bare feet may not come in direct contact with the fabric fibers 114, the plushness of fabric fibers 114, cushioning or insulation of cushioning elements of one or more internal layers 130, and/or warming sensation provided by heating elements of one or more internal layers 130, can still be felt by the users feet. In some embodiment, a thin top protective layer 1110 of the multi-layer mat 100 is not detachable, for example, to always protect the comfort layer 110 from outdoor elements and/or weather elements while still providing a comfortable experience for the user underneath the thin top protective layer 1110.

In some embodiments, the comfort layer 110 and/or one or more internal layers 130 are detachable from the protective layer 120 and/or are otherwise detachable from the multi-layer mat 100. In particular, the comfort layer 110 may get wet and/or dirty from the user's feet and/or from use over time, which may necessitate thorough cleaning that is not possible while attached to the rest of the multi-layer mat. Easy detachment of the comfort layer 110 can enable the comfort layer 110 to be machine washed or otherwise cleaned separately, and/or replaced with a new comfort layer 110. In such embodiments, the easy detachment of comfort layer 110 can be utilized to enable the user to use the comfort layer 110 as a towel and/or to otherwise wipe away moisture or dirt from other parts of their body, for example, once they have changed their footwear while standing upon comfort layer 110 in unprotected feet. The comfort layer 110 can be secured to the rest of the multi-layer mat via a zipper around the perimeter of the multi-layer mat, a plurality of snaps, a plurality of ties, and/or other temporary fasteners. In some embodiments, all of the layers are configured to be machine washable or otherwise deep cleaned, and the comfort layer 110 need not be removed.

FIGS. 12A-12D illustrate an embodiment of multi-layer mat 100 where the comfort layer 110 is both detachable and reversible. FIG. 12A illustrates an configuration where the comfort layer 110 and/or one or more one or more additional internal layers 130 can be detached, via unfastening of a fastening component 1220, from the remainder of the multi-layer mat 100, which includes the protective layer 120 and/or one or more additional internal layers 130. The fastening component 1220 can be implemented via any fastening mechanism discussed previously with regards to the fastening component 720, fastening component 1010, and/or fastening component 1120.

FIG. 12B illustrates a bottom view of the detachable comfort layer 110 depicted in FIG. 12A. The underside of the comfort layer 110, opposite and parallel to the comfort layer surface 112 of the comfort layer 110, can be a protective surface 1112, which can be the same or different protective surface of the same or different thickness and/or material as protective surface 1112 of the top protective layer 1110 FIGS. 11A-11B.

FIGS. 12C and 12D illustrate attachment of the detachable comfort layer 110 of FIGS. 12A and 12B in the usage configuration. The comfort layer 110 and/or one or more one or more additional internal layers 130 can be attached, via the fastening component 1220, to the remainder of the multi-layer mat 100, which includes the protective layer 120 and/or one or more additional internal layers 130. FIG. 12C illustrates attachment of the detachable comfort layer 110 to assume the usage configuration, where the comfort layer surface 112 is exposed to enable the user to step upon the comfort layer 110.

FIG. 12D illustrates attachment of the detachable comfort layer 110 to assume the storage configuration, where the protective surface 1112 is exposed and the comfort layer surface 112 is not exposed to protect the comfort layer 110. The application of detachable comfort layer 110 with protective surface 1112 exposed can be applied alternatively or in addition to rolling and/or folding the multi-layer mat 100 for the multi-layer mat 100 to assume the storage configuration. In some cases, the configuration of FIG. 12D can alternatively or additionally can be utilized to implement the second usage configuration discussed in conjunction with 11B, where the multi-layer mat 100 is flipped over and the user can stand upon the protective layer surface 122 and scrape dirt or snow off of their footwear by utilizing texture elements 124, and where the protective surface 1112 is flush against the ground to protect the comfort layer 110. In some cases, the configuration of FIG. 12D can alternatively or additionally can be utilized to implement the third usage configuration discussed in conjunction with 11B, where the protective layer surface 122 is flush against the ground and the protective surface 1112 is exposed, where the user stands upon the protective surface 1112 with their unprotected feet for a comfortable experience that protects the comfort layer 110 from wetness or dirtying.

In various embodiments, the comfort layer is removable. A reverse-side surface of the comfort layer that is parallel to and opposite the comfort layer surface includes a protective material that is distinct from the material of the comfort layer surface. In the usage configuration, the comfort layer is attached in a first orientation via at least one fastening component to expose the comfort layer surface. In the storage configuration, the comfort layer is attached via the at least one fastening component in a flipped orientation from the first orientation to expose the reverse-side surface.

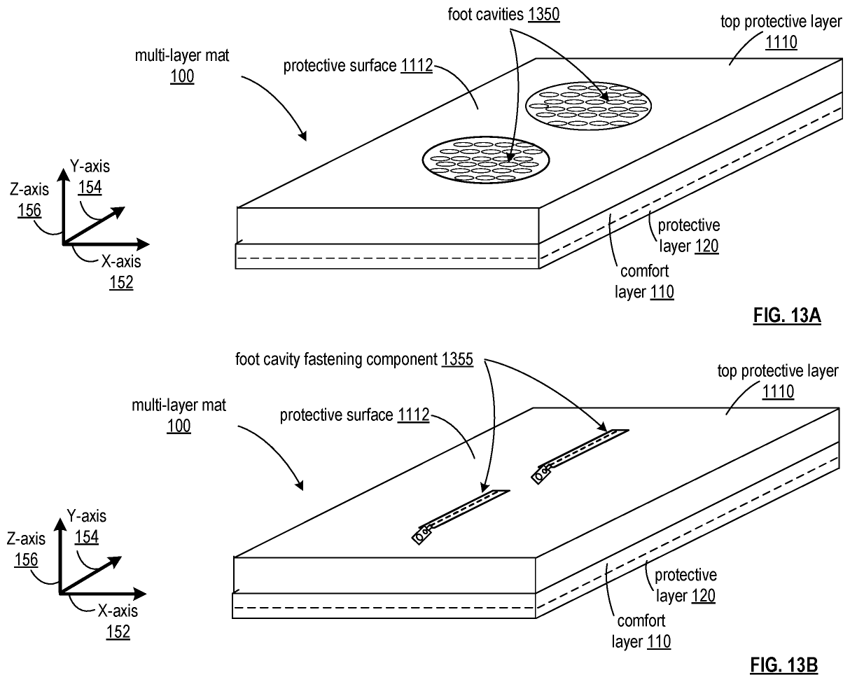

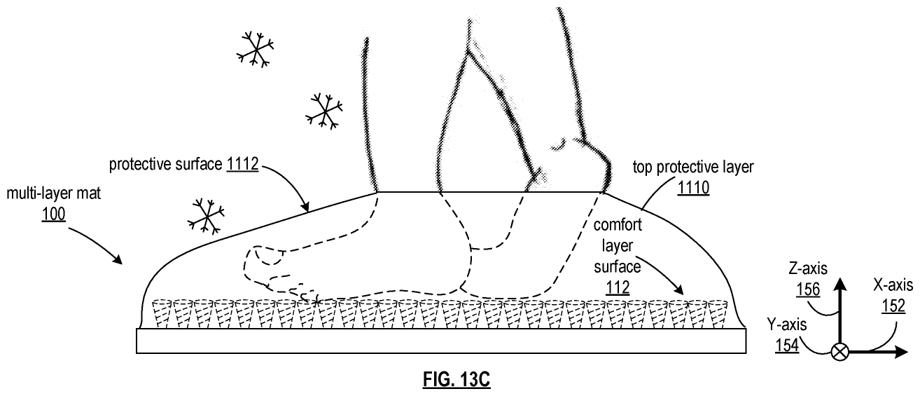

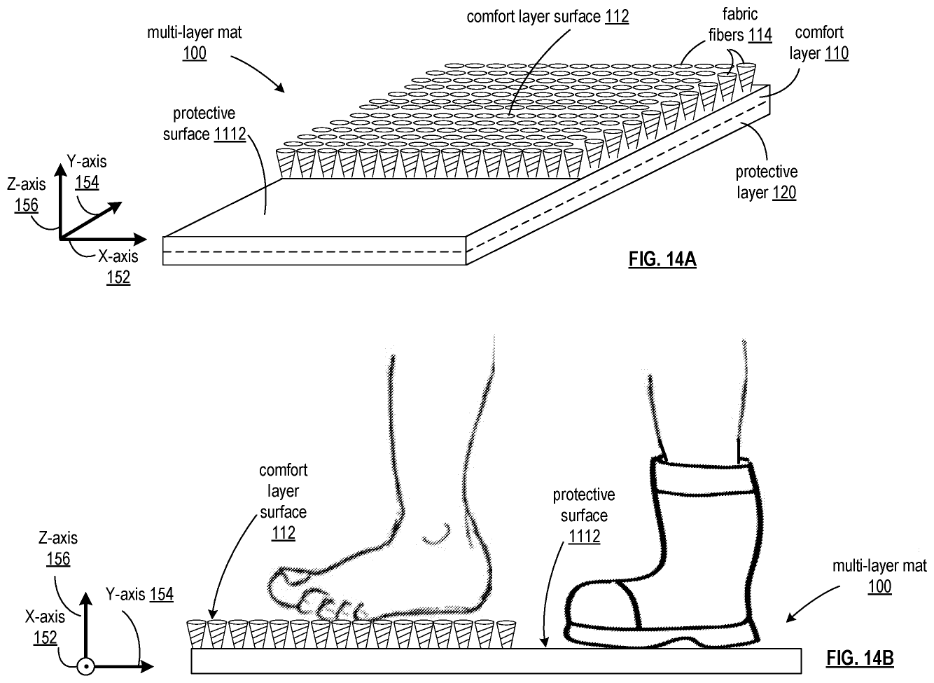

FIGS. 13A-13C illustrate embodiments of multi-layer mat 100 that includes a top protective layer 1110 with one or more foot cavities 1350. The top protective layer 1110 of FIGS. 13A-13C, its thickness, and/or its corresponding material composition, can be the same or different from one or more embodiments of the top protective layer 1110 discussed in FIGS. 11A and 11B. The top protective layer 1110 can be detachable as discussed in FIGS. 11A and 11B, or can be permanently attached to the multi-layer mat to provide protection to the comfort layer 110. The embodiment of FIGS. 13A-13C can correspond to enhanced embodiments of the multi-layer mat 100 of FIG. 1, and features of the multi-layer mat discussed in conjunction with FIGS. 13A-13C can be implemented instead of or in addition to any other embodiments and/or features of multi-layer mat 100.

As illustrated in FIG. 13A, the foot cavities 1350 can correspond to small holes or slots configured for one or more users to insert one of more of their bare and/or socked foot through to make contact with the comfort layer surface 112 underneath. As illustrated in FIG. 13B, the foot cavities 1350 can be configured to open and close via a fastening mechanism of a foot cavity fastening component 1355, such as a zipper fastener as depicted or via any other mechanisms of other fastening components described herein that can enable opening and closing of the foot cavities 1350. In some cases, the foot cavities 1350 do not have any foot cavity fastening component 1355, and thus remain open even when not in use.

FIG. 13C illustrates an embodiment of an enhanced embodiment of the usage configuration of the multi-layer mat 100, where the user insets their feet into the foot cavities 1350 while the multi-layer mat 100 is on the ground. This can be ideal in keeping the user's feet and/or the comfort layer 120 warm and/or dry, protecting the user's feet and the comfort layer 120 from precipitation and/or other weather conditions or outdoor elements. In particular, if it is rainy and/or snowy outside, the user can keep their feet dry and comfortable while changing to help ensure that their feet, are exposed to the elements for a minimal amount of time to change into and/or out of their footwear. This reduces the chances of the user having to endure soaking wet feet and/or socks in their resulting footwear during the activity or after the activity due to having to change in rainy or snowy conditions.

In cases where the foot cavities 1350 have foot cavity fastening component 1355, the opening of foot cavity fastening components 1355 can be included in the transition from the storage configuration to the usage configuration, and the closing of the foot cavity fastening components 1355 can be included in the transition from the usage configuration to the storage configuration. In cases that employ second usage configuration where the multi-layer mat 100 is flipped to expose the protective layer surface 122 for scraping dirt and snow off footwear, the closing of the foot cavity fastening components 1355 can be utilized to protect the comfort layer while flush to the ground in the second usage configuration.

While FIGS. 13A and 13B illustrate a multi-layer mat 100 with two foot cavities 1350, a single foot cavity 1350 can be included in top protective layer 1110 that is configured for both of a user's feet to fit through. In some cases, more than two foot cavities 1350 can be included, for example, on a large mat configured to accommodate multiple people, allowing each person to place one or both of their feet in one or two corresponding foot cavities 1350.

While the foot cavities 1350 of FIG. 13A are illustrated as round holes, the foot cavities 1350 can alternatively or additionally be slots, for example, each corresponding to a single incision of the top protective layer 1110. The foot cavities 1350 can alternatively be any shape that is configured for insertion of one or more feet. In some cases, each foot cavity 1350 is lined with an elastic material, such as elastic cuffs configured to stretch during the insertion of the foot and to secure around the user's ankle once the foot is inserted. This mechanism can be ideal in helping prevent rain and/or snow from enter the foot cavities 1350 while the user's foot is inserted. In some cases, each foot cavity 1350 is lined with a waterproof seal, such as a neoprene, latex, or silicone seal configured to further protect the user's feet and/or the comfort layer 110 from rain, snow, or other outdoor conditions. In some cases, the top protective layer can be comprised of a thin, flexible, and/or elastic material to aid in ease and comfort of insertion and removal of the feet in and out of foot cavities 1350. In some cases, the inner surface of the top protective layer that makes contact with the top of the users feet can be comprised of a comfortable, and/or insulating material, such as a wool, fleece, plush, or other fabric material, for example, lined with down feather elements or other insulating and/or cushioning lining, to provide additional comfort and/or warmth while the user's feet are inserted.

FIGS. 14A and 14B illustrate an embodiment of multi-layer mat 100 that expose both a comfort layer surface 112 and a protective surface 1112 in the usage configuration. The features of multi-layer mat 100 of FIGS. 14A and 14B can be utilized to implement the multi-layer mat of FIG. 1 instead of or in addition to any other features or other embodiments of multi-layer mat 100 discussed herein.

As illustrated in FIG. 14A, a first portion of the exposed, top surface of the multi-layer mat 100 while in the usage configuration includes comfort layer surface 112, and a second portion of the exposed, top surface of the multi-layer mat 100 while in the usage configuration includes protective surface 1112. As illustrated in FIG. 14B, the usage configuration of the multi-layer mat 100 can include standing on the protective surface 1112 with one foot that is wearing footwear, and standing on the comfort layer surface 112 with unprotected feet as discussed previously.

This embodiment can be useful to enable the user to stand on the multi-layer mat 100 with both feet rather than with only one foot when the other foot is wearing footwear that would dirty and/or damage the comfort layer surface 112. This can aid in preventing the multi-layer mat 100 from blowing away and/or flipping over due to windy conditions. For example, when the user must lift their bare foot to apply socks and/or footwear, the other foot wearing footwear and standing upon protective surface 1112 can secure the multi-layer mat 100. As the user may often have to balance and/or lift one foot in applying or removing socks and/or footwear, this configuration can be useful in ensuring that one foot can always be securing the multi-layer mat 100, as the user is unlikely to lift both feet at the same time, while protecting the comfort layer surface 112 from dirtying.

This embodiment can further be useful in enhancing the second usage configuration discussed previously, where rather than having to flip the multi-layer upside down, the user can scrape dirt and/or snow off of their footwear via texture elements included upon protective surface 1112 and/or an edge of the protective surface 1112. In such embodiments, the textured elements 124 can be utilized by the user to scrape their shoes clean, and/or the user can set their shoes on the exposed portion of the protective surface while standing on the comfort layer surface 112 with their unprotected feet.

The protective surface 1112 and/or other portions of top protective layer 1110 can be comprised of any materials of protective layer surface 122 and/or other portions protective layer 120. In some cases, the protective surface 1112 is the same material as protective layer surface 122, for example, based on the portion of the mat exposing protective surface 1112 simply not having any comfort layer and thus exposing the surface protective layer 120 that is opposite from the protective layer surface 122. Alternatively, the protective surface 1112 is a different material, for example based on being a detachable top layer as discussed in conjunction with FIG. 11B, where the detachable top layer covers only half of the comfort layer 110.

The ratio and/or configuration of the protective surface 1112 and the comfort layer surface 112 can be different from the depicted embodiment shown in FIGS. 14A-14B. For example, a center portion of the multi-layer mat 100 along the Y-axis 154 can include comfort layer surface 112, with protective surface 1112 on either end of the multi-layer mat 100 along the Y-axis 154. This example can be useful in allowing the user to place their right foot and left foot, while in footwear, on the left and right side of the multi-layer mat 100 on the respective protective surfaces 1112, rather than having to turn and face the other direction when their opposite foot is wearing footwear.

In some cases, the ratio and/or configuration of the protective surface 1112 and the comfort layer surface 112 can be adjustable and configurable by the user, for example, where the protective surface 1112 is configured to unfold on top of, unroll on top of, and/or slide on top of the comfort layer surface 112 by a configurable amount. This embodiment can be applied in cases where the protective surface 1112 is partially or fully removable as discussed in FIG. 11A-11B. for example, the user can select to attach only a portion of the fastening component 1120 around the perimeter of the multi-layer mat.

As another example where the protective surface 1112 can be configured, the position and orientation of the protective surface 1112 atop the comfort layer surface 112 can be configured by the user. For example, the protective surface 1112 is smaller than the comfort layer surface 112, and the user can select which portion of the comfort layer surface 112 to cover with the protective surface 1112, where the protective surface 1112 is fastened to the comfort layer surface 112 directly. This can be achieved, for example, via hooks of a hook and loop fastener on the underside of the protective surface 1112 and loops of a hook and loop fastener that implement fabric fibers 114.

As another example where the protective surface 1112 can be configured, this can be achieved via a plurality of magnets or other fasteners positioned and dispersed throughout the surface of the multi-layer mat 100, enabling corresponding magnets or other fasteners positioned and dispersed throughout the underside of the protective surface 1112 to be positioned in multiple different possible configurations to secure the protective surface 1112 on top of the comfort layer surface 112.

As another example, a configuration of the multi-layer mats can include a partially-folded configuration, such as a half-way folded configuration, to implement the embodiment of multi-layer mat 100 depicted in FIGS. 14A-14B. For example, the multi-layer mat 100 can be folded as discussed in conjunction with FIGS. 7A-9C, where the mat is not folded in half, but about a different folding point that is not centered, where the resulting fold renders a portion of the protective layer surface 122 as being exposed while keeping a portion of the comfort layer surface 112 exposed, where the remaining portion of the protective layer surface 122 of multi-layer mat is laid upon the ground after this folding to assume the usage configuration of FIGS. 14A-14B. This can be useful in embodiments where the multi-layer mat is particularly pliable, includes a hinged partition 970, is easily secured in this partially-folded position via fastening component 720 such as weighted magnets 950, and/or is otherwise easy to fold and/or remains folded in this configuration, for example, even if the user's weight is not constantly applied to the exposed, folded over protective layer surface 122.

As another example where the protective surface 1112 can be configured, multiple reversible comfort layer panels can be utilized, for example, where each reversible comfort layer panel is implemented by utilizing a smaller embodiment of the reversible comfort layer 110 of FIGS. 12A-12D that includes protective surface 1112 on one side and comfort layer surface 112 on the other side. For example, in the case where the surface of the multi-layer mat 100 is partitioned in to a protective surface 1112 adjacent to a comfort layer surface 112 as depicted in FIG. 14A, two reversible comfort layer panels are utilized and attached to the multi-layer mat 100 via a fastening component. These two reversible comfort layer panels can be congruent or non-congruent based on whether or not comfort layer surface 112 and protective surface 1112 cover the same surface area. To achieve a first configuration depicted in FIG. 14A, one reversible comfort layer panel is configured to expose its protective surface 1112 and where the other reversible comfort layer panel is configured to expose its comfort layer surface 112. In this case, three more configurations can be assumed, including: a second configuration where the entire surface of multi-layer mat 100 is protective surface 1112 based on both reversible comfort layer panels being attached with their protective surface 1112 exposed; a third configuration where the entire surface of multi-layer mat 100 is comfort layer surface 112 based on based on both reversible comfort layer panels being attached with their comfort layer surface 112 exposed; and a fourth configuration where the both reversible comfort layer panels are flipped from that depicted in the first configuration, where the fourth configuration is distinct from the first configuration if the reversible comfort layer panels are not congruent and/or otherwise have different sized and/or shapes. Note that other embodiments that provide even more configuration options can have more than two reversible comfort layer panels. Note that that other embodiments that provide even more configuration options can include more than two types of materials utilized to implement various surfaces of different reversible comfort layer panels, which can be utilized to adapt to differing weather conditions, temperature conditions, and/or desired level of comfort.

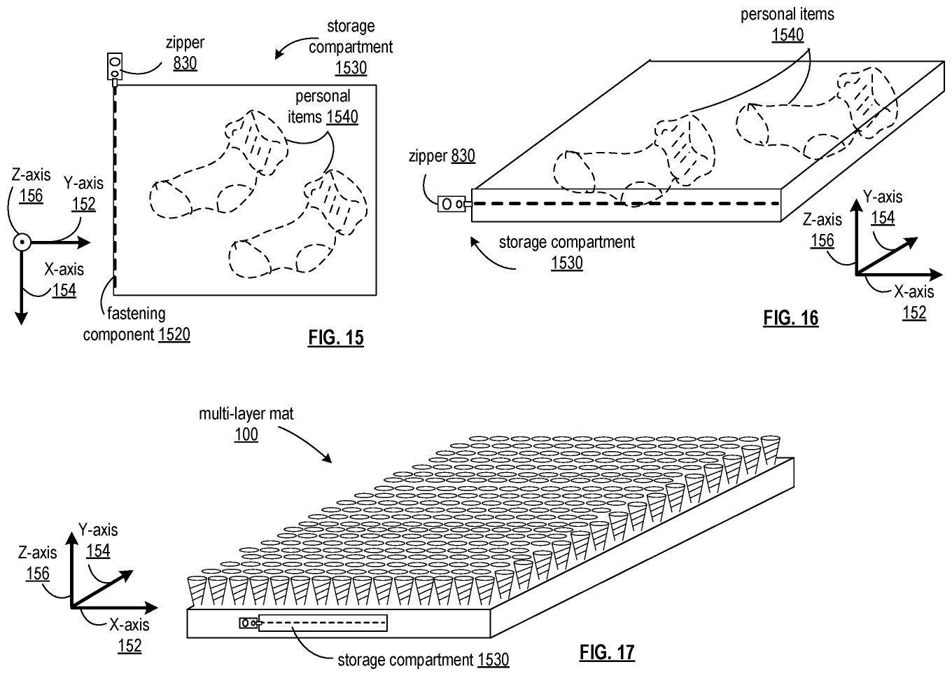

FIGS. 15-17 illustrate an embodiment of a multi-layer mat 100 that includes at least one storage compartment 1530. The storage compartment 1530 can be utilized to secure personal items 1540 in the multi-layer mat 100. At least one storage compartment 1530 of FIGS. 15-17 can included in the multi-layer mat instead of or in addition to any other features and/or embodiments of the multi-layer mat 100 discussed herein.

In some embodiments, the comfort layer 110, protective layer 120, and/or an internal layer 130 includes a pocket that is accessible by the user via a zipper or other slot along the side of the mat, the comfort layer surface 112 of the mat, or the protective layer surface 122 of the mat. This can be utilized to secure small items such as keys, wallet, credit cards. In some embodiments, such pockets can be configured to secure a change of socks or other garments and/or a pair of sandals or other change of footwear. This can be useful in ensuring the change of socks and/or footwear are protected and easily accessible once the user removed their footwear and/or socks after their activity or before their activity, allowing the user to easily access the change of socks and/or footwear without leaving the mat. This ensures that the user does not need to step on the ground in their unprotected feet to fetch the change of socks, footwear, or other garments.

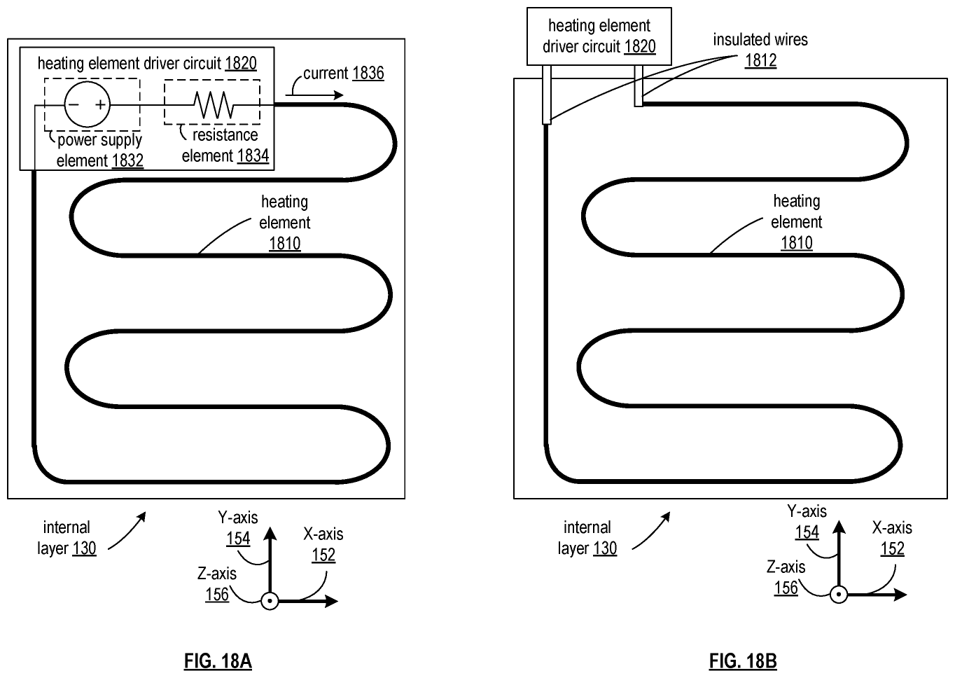

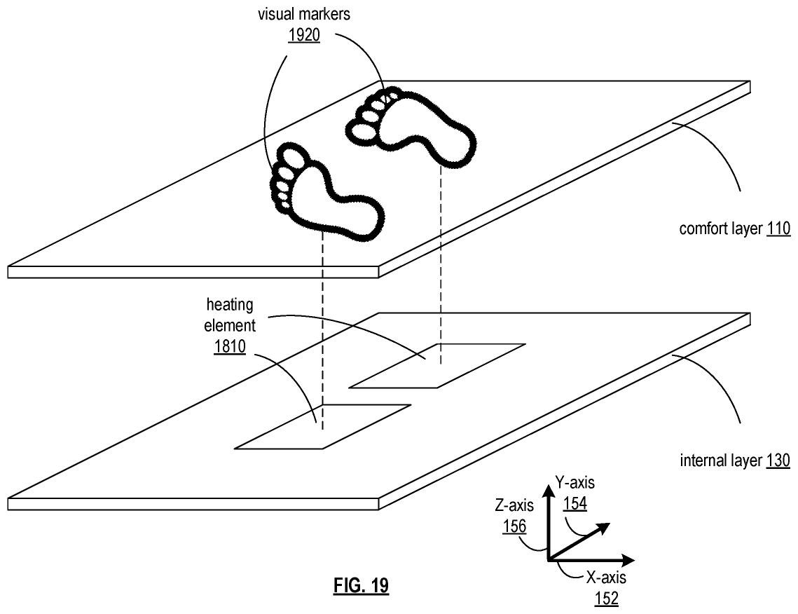

FIG. 15 depicts a top view of a storage compartment 1530, and FIG. 16 illustrates a three-dimensional view of a storage compartment 1530. The storage compartment can include an inner cavity accessible via one or more holes and/or slots exposed to one or more surfaces of the multi-layer mat 100, as illustrated in FIG. 17. This exposed hole and/or slot of the storage compartment 1530 can optionally be opened and closed via a fastening component 1520, which can be implemented utilizing a zipper as depicted in FIG. 15 and/or can be implemented utilizing any other fastening mechanisms discussed in embodiments of fastening component 720, fastening component 1010, fastening component 1120, and/or any other fastening components described herein. In some cases, the exposed hole and/or slot of the storage compartment 1530 can optionally be opened and closed via one or more flaps and/or can include a drawer and/or sliding mechanism that can be pulled in and out of the storage compartment 1530 for insertion and removal of items.

The storage compartment 1530 can be configured to secure personal items 1540 associated with the user such as socks, keys, wallets, snack bars, and/or other personal items. The storage compartment 1530 can be useful in keeping these personal items dry, clean, and protected from the outdoor elements. The storage compartment 1530 can be further useful in keeping valuable items protected and hidden, for example, while the user is engaging in their activity. The storage compartment 1530 can be useful to secure additional items while carrying the multi-layer mat 100 rather them carrying them separately, for example, on a hike and/or bike ride where the user is carrying the multi-layer mat via straps 710.

In some embodiments, the storage compartment 1530 can be useful to keep certain items easily accessible by the user when using the multi-layer mat 100 in the usage configuration. For example, as depicted in FIGS. 15 and 16, the user can store a change of socks in the multi-layer mat 100 that they intend to change into while using the multi-layer mat 100 in the usage configuration to help ensure these socks stay dry and clean until the user puts them on, and/or to help prevent the user from forgetting their socks. This can mitigate problems presented in the case where the user remembers, only after removing their footwear via usage of the multi-layer mat 100, that they left their change of socks in the car, and therefore must step off the multi-layer mat 100 and dirty their unprotected feet on the ground to fetch their change of socks in the car, or put their footwear back on to fetch their change of socks in the car.

Storage compartment 1530 can be accessible along a side of the mat, such as a side parallel to the plane defined by the Z-axis 156 and X-axis 152 as depicted in FIG. 17. The storage compartment 1530 can be accessible along one of the three other sides of the mat that include the Z-axis, such as the other side parallel to the plane defined by the Z-axis 156 and X-axis 152 and/or the side parallel to the plane defined by the Z-axis or the Y-axis. In such cases, one or more storage compartments 1530 can be included in one or more internal layers 130 of the mat. In some cases, the storage compartment can be implemented by a cavity between two layers of the mat, such as a cavity between the comfort layer 110 and the protective layer 120, a cavity between comfort layer 110 and an internal layer 130, a cavity between protective layer 120 and an internal layer 130, and/or a cavity between two internal layers 130. In some cases, the storage compartment can be implemented by a cavity inserted into a particular layer, such as a cavity of a thick layer, such as a thick protective layer 120 and/or thick, cushioning elements of an internal layer 130, that can accommodate the width of the storage compartment 1530 along the Z-axis 156. Storage compartment 1530 alternatively or additionally can be accessible via protective layer surface 122 of the mat and/or comfort layer surface 112 via a hole or slot, where the storage compartment 1530 is implemented via a cavity in protective layer surface 122 of the mat and/or comfort layer surface 112 and/or optionally protrudes into one or more additional internal layers 130.

In some cases, rather than to being bounded and protected by the surfaces of layers adjacent to a cavity in multi-layer mat 100 that implements the storage compartment 1530, the storage compartment 1530 can be further lined by a fabric, insulated, and/or weather protective material, such as a thin fabric and/or a material discussed previously to implement one or more embodiments of the top protective layer 1110, and/or can be lined with a more rigid plastic and/or rubber material. For example, an insulating material can keep socks from getting too cold in cold weather and/or can keep keys or metal valuables from getting too hot in hot weather.

The multi-layer mat 100 can be configured so that the user can stand on the multi-layer mat 100 without feeling the personal items in the storage compartment 1530 and/or without being at risk of damaging the valuables contained in storage compartment 1530. For example, the storage compartment 1530 can be placed under a thick cushioning elements of an internal layer 130 and/or can be lined with a thick, protective, and/or cushioned material itself. In other embodiments, assuming the usage configuration can include removal of one or more items from the storage compartment 1530, while assuming the storage configuration can include inserting one or more items into the storage compartment 1530 for storage, for example, when the multi-layer mat 100 is in the vehicle in the parking lot while the user engages in their activity, while the multi-layer mat 100 is transported in a vehicle to and/or from the location of the activity, and/or while the multi-layer mat 100 is carried in the storage configuration by the user, for example, via straps 710, during a hike and/or a bike ride.

While FIG. 17 depicts a multi-layer mat 100 with a single storage compartment 1530, other embodiments of multi-layer mat can include multiple, distinct storage compartments 1530 on the same or different sides and/or surfaces of the mat. The storage compartment 1530 depicted in FIG. 17 is small relative to the size of the multi-layer mat 100, where the storage compartment 1530 is configured to secure only small personal items such as socks, keys, a wallet, and/or a small snack such as a protein bar. For example, where storage compartment 1530 is roughly six inches by six inches along the X-axis 152 and the Y-axis 154, and is roughly one or two centimeters thick along the Z-axis 156.

In other embodiments, the storage compartment 1530 can be any size that can be accommodated by the size of the multi-layer mat 100. For example, the surface of storage compartment 1530 parallel to the plane defined by X-axis 152 and Y-axis 154 can span a significant proportion of the area of the multi-layer mat 100 parallel to the plane defined by X-axis 152 and Y-axis 154, such as greater than fifty percent. In such cases, a user can store larger and/or bulkier items, such as other change of clothing such as pants, shirts, jackets, hats, scarves, undergarments, sandals, and/or other footwear. In some embodiments, a larger compartment is utilized to implement an internal layer 130, where the user's own clothing acts as a cushioning element while the multi-layer mat 100 is in the usage configuration to provide additional comfort for the user's feet. In such cases, the user can remove these bulkier items before the multi-layer mat 100 assumes the storage configuration, for example, to ensure the multi-layer mat 100 can more easily fold and/or roll.

Alternatively or in addition, one or more internal layers 130 can be customizable by the user via a storage compartment 1530 based on their desired level of comfort and/or the current weather and/or temperature conditions. The user can insert their own cushioning elements and/or heating elements into a storage compartment 1530, where the user can customize placement, type, thickness, and/or amount of cushioning inserted and/or can customize placement, type, and/or amount of heating element inserted. The cushioning elements and/or heating elements can therefore be configured to be removable and/or adjustable. Alternatively, the cushioning elements and/or heating elements can be provided by the user, for example, based repurposing other items they may already own that serve cushioning and/or heating functionality and can be inserted into storage compartment 1530. In such cases, in the usage configuration, the user-selected cushioning elements and/or heating elements are inserted into storage compartment 1530 to provide a configured level of comfort while the user is standing on the multi-layer mat 100. In the storage configuration, these items user-selected cushioning elements and/or heating elements can be removed from into storage compartment 1530, for example, to more easily enable the multi-layer mat 100 to assume its storage configuration and/or to make the multi-layer mat 100 lighter and/or less bulky to carry. A particular example embodiment of compartments utilized to store removable heating elements is discussed in further detail in conjunction with FIGS. 22-24.

FIGS. 18A-24 illustrate embodiments of a multi-layer mat 100 that includes a heating element. This can be ideal in providing additional warmth and comfort to the user's feet while multi-layer mat 100 is in the usage configuration. For example, in cases where the multi-layer mat 100 is used in winter conditions to aid in a user changing into and/or out of ski boots and/or snowboarding boots, this feature can be especially useful in keeping the user's exposed feet comfortable in cold conditions. Some or all features and/or embodiments discussed in conjunction with FIGS. 18A-24 can be utilized to implement the multi-layer mat 100 of FIG. 1 instead of or in addition to any other features and/or embodiments of the multi-layer mat 100 discussed herein.

As illustrated in FIGS. 18A and 18B, an internal layer 130 of the multi-layer mat can include a heating element 1810, and/or heating element 1810 can otherwise be placed within and/or in a cavity between comfort layer 110 and protective layer 120. The heating element 1810 can be implemented via one or more electrical heating wires integrated into multi-layer mat 100 as depicted in FIGS. 18A and 18B. These electrical heating wires can be comprised of a conductive material such as a metallic resistance wire elements, ceramic elements, semiconductor elements, conducting PCT rubber elements, and/or other elements that can convert electrical energy into heat, For example, the electrical heating wires can be implemented via nichrome materials, carbon fiber materials, or other conductive materials and/or radiative materials. Insulating material can be applied to protect other elements of the multi-layer mat 100 from the electrical heating wires and/or heat-proof and/or fire-proof materials can be applied to other elements of the multi-layer mat 100.

The heating element 1810 can be permanently or semi-permanently integrated within the multi-layer mat 100 via stitching, adhesive, glue, and/or other permanent fastening and/or attachment mechanism. The heating element 1810 can otherwise be embedded within between layers of the multi-layer mat 100, and can be permanently or semi-permanently integrated within the multi-layer mat 100 based on the sides of multi-layer mat 100 being permanently or semi-permanently attached to enclose the heating element 1810 within the multi-layer mat 100. In some cases, some or all of heating element 1810 can be removed from multi-layer mat 100, for example, to enable cleaning of other layers of the multi-layer mat 100 and/or for replacement and/or recharging of batteries of the heating element 1810.

A heating element driver circuit 1820 can be implemented to deliver current 1836 to heating element 1810 to enable the heating element 1810 to generate heat via Joule heating, based on a resistance of the heating element 1810. This current 1836 can be dictated by a voltage delivered via power supply element 1832, resistance of a resistance element 1834 such as one or more resistors of the driver circuit, and/or additional resi 2080

stance of the heating element 1810 itself.

The power supply element 1832 can be implemented via one or more disposable batteries and/or via one or more rechargeable batteries, for example, where the batteries are included in the multi-layer mat 100, such as in a designated storage compartment 1530 configured to permanently or temporarily store a battery pack and facilitate a powered connection to the heating element driver circuit 1820. Alternatively, the heating element driver circuit 1820 can have a wired connection to a power source that is separate from the multi-layer mat. For example, the heating element driver circuit 1820 can have a wired direct current (DC) power connection to a separate battery pack, a wired direct current (DC) power connection to an automobile auxiliary power outlet of an automobile, and/or a wired alternating current (AC) connection to an AC power outlet. For example, the heating element driver circuit 1820 can be plugged into and/or otherwise connected to a power source to assume the usage configuration, and the heating element driver circuit 1820 can be unplugged and/or disconnected from the power source to assume the storage configuration. At least one power converter can be utilized to convert AC power to DC power, to convert DC power to AC power, and/or to deliver a predetermined voltage to power supply element 1832.

As illustrated in FIG. 18A, the hardware elements of the heating element driver circuit 1820 can be physically integrated within the multi-layer mat 100. For example, the hardware elements of the heating element driver circuit 1820 can be included in one or more layers of the multi-layer mat 100 and/or in a storage compartment 1530 configured to permanently or temporarily store the heating element driver circuit 1820. Alternatively, as illustrated in FIG. 18B, the hardware elements of the heating element driver circuit 1820 can be separate from the multi-layer mat 100, and can be permanently connected to, and/or temporarily connected to and disconnected from, the multi-layer mat 100 via insulated wires 1812 or other connecting elements that enable the heating element driver circuit 1820 to deliver current to the heating element 1810 integrated within multi-layer mat 100. In the embodiment illustrated in FIG. 18B, the heating element driver circuit 1820 can be connected to the multi-layer mat 100 in the usage configuration to deliver current to the heating element 1810 when the multi-layer mat 100 and provide warming to the user's feet while standing on the mat, and the heating element driver circuit 1820 can be disconnected to the multi-layer mat 100 to assume the storage configuration to enable the multi-layer mat to be more easily folded, rolled, transported and/or stored, as the heating element 1810 does not need to be heated while in storage and/or transport.

The heating element 1810 can be configured to be dispersed and/or integrated throughout the mat, for example, to provide relatively even heating uniformly distributed throughout the multi-layer mat 100. In some cases, as the surface area of comfort layer 110 that will be covered by the user's feet may be relatively small, such as less than twenty percent of the entire surface area of comfort layer 110, the heating element 1810 can be configured to heat only a specified area of the multi-layer mat, for example, where the user can stand in this designated portion of the mat to warm their feet. This can aid in preserving the amount of power necessary to deliver current to the heating element 1810 and/or can enable a greater amount or more concentrated heating to be delivered to this smaller portion of the comfort layer surface 112.

FIG. 19 illustrates such an embodiment where the heating element integrated only in a small portion of the portion of multi-layer mat 100 that intersects a plane parallel to a plane defined by the X-axis 152 and Y-axis 154. In this example, two discrete portions of an internal layer 130 have an integrated heating element 1810. These discrete portions can be connected in series and/or in parallel, enabling current to be delivered from the same heating element driver circuit 1820, and/or can have separate heating element driver circuits 1820. In some cases, rather than two distinct portions having integrated heating elements 1810, a single portion of internal layer 130, for example, centered in internal layer 130, can have an integrated heating element 1810.

Directly above these discrete one or more portions of an internal layer 130 with integrated heating elements 1810 with respect to Z-axis 156, the comfort layer surface can optionally include visual markers 1920 that visually indicate to the user where their feet should be placed upon the multi-layer mat to be provided with the warmth generated by heating elements 1810. These visual markers 1920 can be printed, painted, stitched, and/or otherwise visually indicated on the comfort layer surface 112, or optionally upon the surface of a top protective layer 1110 if the usage configuration includes stepping upon top protective layer 1110 as discussed previously. In embodiments where a top protective layer 1110 is included with foot cavities, the one or more distinct portions of internal layer 130 with integrated heating elements 1810 can be placed directly under these foot cavities, where the foot cavities are implemented as the visual markers 1920. The visual markers 1920 can be roughly foot shaped and/or depicted as footprints as illustrated in FIG. 19, where the user steps their feet upon these visually depicted footprints. In other embodiments, the visual markers 1920 can be any outlined or shaded shape that otherwise visually indicates a distinct region of the multi-layer mat to be stepped upon for the user's feet to be warmed.

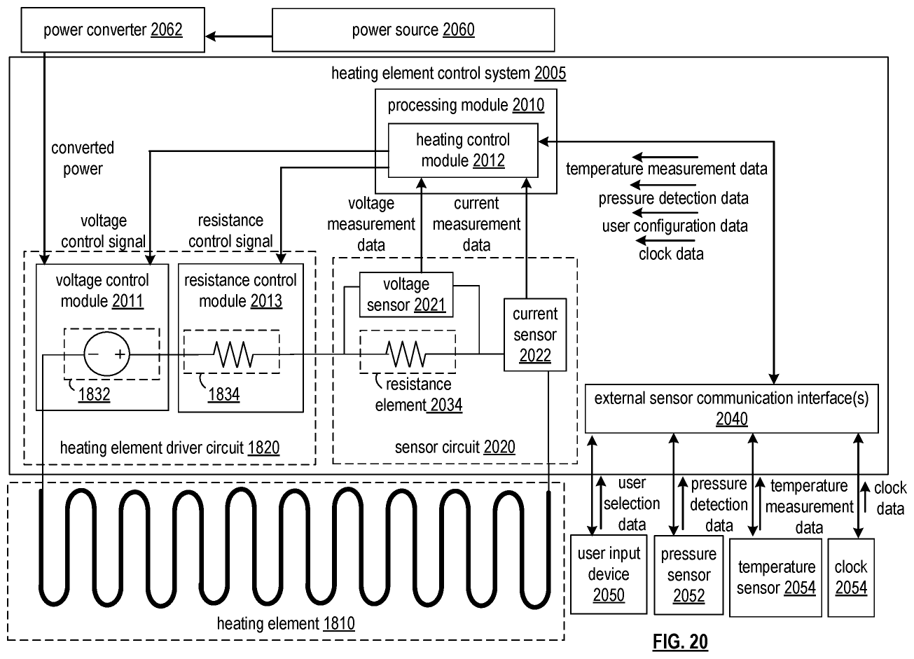

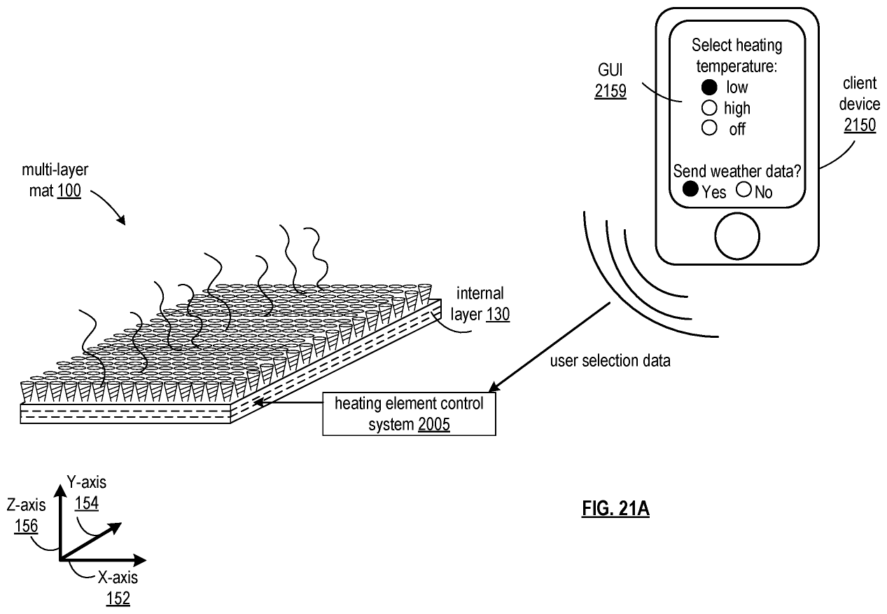

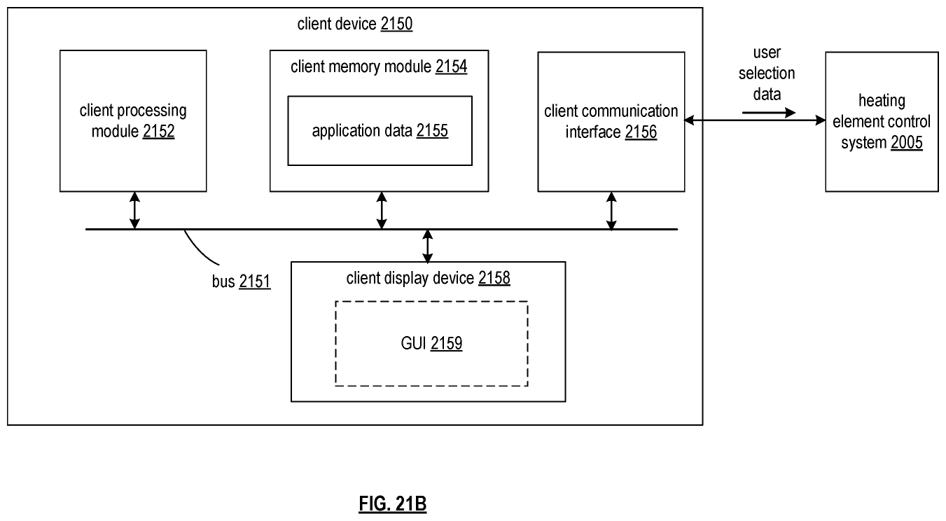

FIG. 20 presents an embodiment of a heating element control system 2005 that can be utilized to regulate and/or control current delivered to the heating element 1810 to control an amount and/or intensity to which heating element 1810 is heated. In particular, the heating element control system 2005 can dynamically adjust the current delivered to the heating element 1810 in accordance with a predetermined heat level to be outputted by the heating element. A processing module 2010 of the heating element control system can include one or more processors and/or at least one memory to implement a heating control module 2012. For example, executable instructions can be stored by the at least one memory and can be executed by the one or more processors to implement the functionality of the heating control module 2012.

Some or all of the hardware elements utilized to implement the heating element control system 2005 can be physically integrated within the multi-layer mat 100. For example, the hardware elements of the heating element control system 2005 can be included in one or more layers of the multi-layer mat 100 and/or in a storage compartment 1530 configured to permanently or temporarily store the heating element driver circuit 1820. Alternatively, some or all of the hardware elements of the heating element control system 2005 can be separate from the multi-layer mat 100, and can be permanently connected to, and/or temporarily connected to and disconnected from, the multi-layer mat 100 via insulated wires 1812 or other connecting elements that enable the heating element control system 2005 to control the heating element driver circuit 1820.

In some cases, the current can be dynamically adjusted based on dynamically adjusting the voltage delivered via power supply element 1832 of the heating element driver circuit 1820. For example, the power supply element 1832 can be implemented by utilizing a voltage regulator, a voltage controller, a potentiometer, and/or other element that can dynamically adjust a level of voltage of the power supply element 1832. The heating control module 2012 can generate a voltage control signal based on a determined level of current to be delivered to the heating element 1810 and/or a determined increase and/or decrease the present level of current being delivered to the heating element 1810. A voltage control module 2011 can dynamically adjust the level of voltage based on the voltage control signal received from the heating control module 2012. For example, a power converter 2062 generates converted power from a power source 2060 to deliver converted power to the heating element control system, and the voltage control module can serve as a dynamic voltage divider and/or can otherwise utilize a determined portion of the converted power to implement the power supply element 1832 based on the voltage control signal. The power converter 2062 and/or power source 2060 can be integrated into the multi-layer mat 100 or can be separate from the multi-layer mat 100, attached to the heating element control system 2005 and/or the heating element driver circuit 1820 via a wired connection.

Alternatively or in addition, the current can be dynamically adjusted based on dynamically adjusting the resistance of resistance element 1834 of the heating element driver circuit 1820. For example, the resistance element 1834 can be implemented by utilizing a potentiometer and/or rheostat. The heating control module 2012 can generate a resistance control signal based on a determined level of current to be delivered to the heating element 1810 and/or a determined increase and/or decrease the present level of current being delivered to the heating element 1810. A resistance control module 2013 can dynamically adjust the resistance of resistance element 1834 based on the resistance control signal received from the heating control module 2012.

The heating control module 2012 can determine the level of current to be delivered to the heating element 1810 and/or a determined increase and/or decrease the present level of current being delivered to the heating element 1810 based on sensor input from one or more sensors. The one or more sensors discussed herein can be included and/or integrated within the heating element control system 2005, and/or can communicate data to the heating element control system 2005 via a wired and/or wireless connection to the heating element control system 2005 via one or more external sensor communication interfaces 2040 of the heating element control system 2005.

The one or more sensors discussed herein can be included and/or integrated within the multi-layer mat 100 itself. For example, some or all sensors can be included in one or more layers of the multi-layer mat 100 and/or in a storage compartment 1530 configured to permanently or temporarily store the sensors, where a wired connection from the sensors to the external sensor communication interface 2040 is also integrated in one or more layers of the multi-layer mat 100 and/or is facilitated via a wireless transmissions through one or more layers of the multi-layer mat 100. Alternatively, one or more of the sensors discussed herein can be separate from the multi-layer mat 100, and communicate with the heating element control system 2005 via a wired connection that is separate from the multi-layer mat 100 and/or via a wireless connection.

The heating control module 2012 can be configured regulate a consistent heating level of the heating element 1810 and/or can be configured to adjust current accordingly to ensure a predetermined level of heating, such as a temperature, intensity, and/or other amount of heating, is met by heating element 1810. For example, even if the predetermined level of heating is fixed, adjustments to the level of current to the heating element 1810 may be required under differing conditions. In particular, as the multi-layer mat is configured for outdoor use, the resistance of the heating element 1810 may vary as a result of different ambient outdoor temperatures induced during different times of year and/or in different weather conditions. If a same current is always configured to be delivered by the heating element driver circuit 1820, differing levels of heating would therefore be attained in differing conditions due to responsive changes in resistance, which could potentially result in undetectably low amount of heating and/or a dangerously high level of heating.

The heating control module 2012 can be configured to adapt to varying outdoor weather conditions ensure an appropriate level of current is delivered to meet the predetermined level of heating by detecting and adapting to variability of the resistance of the heating element 1810 and/or other conditions that cause the resistance of the heating element 1810 to change. In particular, the sensors included in and/or communicating with the heating element control system can include a voltage sensor 2021 and/or a current sensor 2022 of a sensor circuit 2020. The sensor circuit 2020 can integrated within the multi-layer mat 100 and/or separate from the multi-layer mat with a wired connection to the heating element 1810 and/or the heating element driver circuit 1820 to enable the heating element driver circuit 1820 to measure voltage and/or current of the heating element and/or the heating element driver circuit 1820. The voltage sensor 2021 can generate voltage measurement data that is sent to the heating control module 2012 and/or the current sensor 2022 can generate current measurement data that is sent to the heating control module 2012. For example, the voltage sensor 2021 is connected in parallel to measure voltage across a portion of circuit with resistance element 2034 with known resistance that, for example, is less susceptible to varying with changes in temperature than the resistance of the heating element 1810. The heating control module 2012 can utilize the received voltage measurement data and/or the received current measurement data to determine resistance of the heating element 1810 and/or to determine an amount of current to be delivered to the heating element to attain the redefined level of heating. The heating control module 2012 generate and/or adjust the level of voltage and/or amount of resistance to be applied in generating the voltage control signal and the resistance control signal based on the to determine an amount of current to be delivered to the heating element 1810.

In some embodiments, alternatively or additionally to utilizing voltage measurement data and/or current measurement data, the heating control module 2012 can receive temperature measurement data from a temperature sensor. This can include one or more temperature sensors that measure a surface temperate and/or internal temperature of the heating element 1810. In this case, the temperature measurement data can be utilized in a similar fashion as discussed with regards to the voltage measurement data and/or current measurement data, where the heating control module 2012 adjusts the current delivered to the heating element 1810 to decrease and/or increase the level of heating of the heating element 1810 from its measured temperature to meet the predetermined heating level.

In some embodiments, one or more temperature sensors can alternatively or additionally be configured to measure ambient temperature of the environment. For example, a thermometer integrated in the multi-layer mat 100 and/or communicating collected measurements with the external sensor communication interface 2040. In some cases, the external sensor communication interface 2040 can receive temperature and/or other weather data received via a network connection to the Internet, and/or can receive temperature a mobile device of the user that receives weather data from the Internet and relays the weather data to the heating element control system via external sensor communication interface 2040.

In such embodiments, rather than having a single, fixed predetermined heating level, the heating control module 2012 can have different predetermined heating levels stored for different ambient temperatures and/or the heating level can be determined as a predetermined function of ambient temperature. For example, on a warm summer day, heating of the feet via heating element 1810 may not be desirable. As another example, increasingly colder weather can warrant increasingly high levels of heating. As another example, other weather conditions detected by sensors of the multi-layer mat and/or collected via external sensor communication interface 2040, such as precipitation and/or wind chill, can also warrant higher levels of heating than conditions with no precipitation and/or no wind chill. In such cases, the heating control module 2012 can determine the heating level as a function of, or otherwise based on, the temperature data. The heating control module 2012 can determine the appropriate level of current accordingly based on the determined heating level. This appropriate level of current can be further based on the voltage measurement data, current measurement data, and/or measured temperature of the heating element itself as discussed previously. The appropriate level of current, given the determined heating level, can optionally be determined based on a known resistance of the heating element 1810, for example, if the heating element 1810 is known to have a sufficiently consistent resistance to cause relatively consistent heating level of the heating element 1810 in varying temperatures that the multi-layer mat 100 is expected to encounter in outdoor use. The appropriate level of current can be utilized to generate the voltage control signal and resistance control signal accordingly. In some cases, if the temperature is above a predetermined threshold temperature, no current is delivered to the heating element 1810.

The one or more sensors can alternatively or additionally include a clock 2054. The heating element control system 2005 can receive clock data from a clock 2054 that keeps and/or determines absolute or relative time. For example, the clock 2054 can be implemented as a timer, where the heating control module 2012 dictates that current only be delivered to the heating element 1810 for a predetermined amount of time. As another example, the heating control module 2012 dictates that current be delivered to the heating element 1810 starting a predetermined amount of time after a determined starting time. As another example, the clock 2054 generates clock data indicating absolute time, and the heating control module 2012 dictates that current be delivered to the heating element 1810 at a certain time of day, week, month, or year, and/or dictates that current not be delivered to the heating element 1810 at a certain time of day, week, month, or year, for example, based on predetermined heating element scheduling data.

In some embodiments, the one or more sensors can alternatively or additionally include one or more pressure sensors 2052 integrated within the multi-layer mat 100 to generate pressure detection data indicating whether or not a user is standing on the mat. For example, the heating control module 2012 dictates that current be delivered to the heating element 1810 in response to the pressure detection data indicating the user is standing on the mat, and the heating control module 2012 dictates that current not be delivered to the heating element 1810 in response to the pressure detection data indicating the user is not standing on the mat.

Other sensors can be alternatively or additionally be integrated within the multi-layer mat 100 to detect whether the multi-level mat is has transitioned from its storage configuration or its usage configuration and/or to detect whether the multi-level mat is has transitioned from its usage configuration or its storage configuration. For example, one or more accelerometers or gyroscopes can be implemented to detect whether the mat has been unfolded, unrolled, uncovered, and/or oriented face up on the ground in its usage configuration. As another example, one or more light sensors on the comfort layer surface 112 can be implemented to detect changes in lighting to determine whether or not the comfort layer surface 112 is exposed due to the multi-layer mat 100 being in the usage configuration and/or is unexposed due to the multi-layer mat 100 being in the storage configuration. In such cases, the heating control module 2012 dictates that current be delivered to the heating element 1810 in response to sensor data indicating the multi-layer mat 100 has transitioned from the storage configuration to the usage configuration, and the heating control module 2012 dictates that current not be delivered to the heating element 1810 in response to the sensor data indicating the multi-layer mat 100 has transitioned from the storage configuration to the usage configuration.

Alternatively or in addition to collecting and utilizing other sensor data discussed herein, the user can configure their own heating level preferences as user selection data via user input to a user input device 2050. This user input device 2050 can be custom to the heating element 1810 and/or the multi-layer mat 100, and can include adjustable knob, buttons, and/or other user input elements that enable the user to select and/or adjust between one or more heating levels and/or simply enable the user to turn the heating element 1810 on and off. Alternatively, the user input device 2050 can be implemented via a client device, such as a cellular device, mobile device, smart phone device associated with the user, and/or graphical user interface of a vehicle associated with the user. Implementation of user input device 2050 via a client device client device is discussed in further detail in conjunction with FIGS. 21A-21B.

Some or all of the predetermined parameters discussed with regards to the heating element control system 2005 can be fixed and/or stored in at least one memory accessible by the processing module 2010. Alternatively, user selection data can be utilized to determine some or all predetermined parameters and/or configure the predetermined parameters based on user selection of some or all predetermined parameters via interaction with a user input device 2050.

The user selection data can indicate a user selection for heating level to be immediately delivered via heating element 1810. Alternatively, the user selection data can correspond to user preferences to be stored by at least one memory accessible by the processing module 2010. For example, the user selection data can indicate the predetermined heating level, the predetermined function to determine the heating level as a function of ambient temperature, the predetermined threshold temperature dictating whether or not the heating element 1810 should be heated, the predetermined timer data for elapsing of heating of the heating element 1810, predetermined amount of time from a starting time until the heating element 1810 should be heated, predetermined scheduling data for heating of heating element 1810, and/or other preferences that can be stored and utilized for subsequent usages of the multi-layer mat and/or that can be reconfigured by the user via additional user selection data generated and sent to the heating element control system 2005 at a later time.

In some cases, the user input device and/or the heating element control system 2005 can track and/or store historical data regarding the user selection data generated and/or received over time. The processing module 2010 and/or a processing module of the user input device can automatically apply a data analytic function and/or machine learning algorithm to generate learned user preference data. This learned user preference data can be sent to the heating element control system 2005, can be stored in memory of the heating element control system 2005 to set some or all predetermined parameters, and/or can be sent to the heating control module 2012, where the heating control module 2012 controls the current delivered to the heating element 1810 based on the learned user preference data.

For example, the learned user preference data can indicate that the user tends to turn on the heating element only when the ambient temperature is lower than forty degrees Fahrenheit, and the heating control module 2012 can automatically turn on the heating element only when the ambient temperature is indicated in the temperature data as being lower than forty degrees Fahrenheit. As another example, the learned user preference data can indicate that the user tends to assume the usage configuration of the multi-layer mat and turn on the heating element 1810 on Saturdays at 4 pm in the winter months, for example, based on the user electing to partake in skiing activities every weekend during ski season and further electing to ski until the ski lifts close.

In various embodiments, multi-layer mat 100 includes a heating element control system and further includes: a current sensor configured to capture current measurements of the heating element, a voltage sensor configured to capture voltage measurements of the heating element, and/or a temperature sensor configured to capture temperature measurements. The heating element control system dynamically adjusts a current delivered to the heating element in accordance with a predetermined heat level to be outputted by the heating element based on the current measurements, the voltage measurements, and/or the temperature measurements.

In various embodiments, the current is delivered to the heating element via a heating element driver circuit, and the current is dynamically adjusted via a potentiometer of the heating element driver circuit, a rheostat of the heating element driver circuit, and/or a voltage regulator of the heating element driver circuit.

FIGS. 21A and 21B illustrate an example embodiment where the user input device 2050 is implemented via a client device 2150 associated with the user. The client device can display a graphical user interface (GUI) 2159 prompting the user to make selections regarding the heating level, and the client device can generate user selection data based on the user selections in response to the prompts. For example, the GUI 2159 can prompt the user to select one of a plurality of possible heating levels, and/or to simply elect to turn the heating element one and/or off. In the example GUI 2159 depicted in FIG. 21A, the user is prompted to select whether the heating element 1810 be set to a low temperature, a high temperature, or turned off. Other embodiments can include a wider range of options and/or can allow the user to provide more specificity in their desired heating level. As another example, the GUI 2159 can prompt the user to make selections to configure one or more of the predetermined parameters discussed previously.

This user selection data can be sent to the heating element control system 2005, and the heating element control system 2005 can control current delivered to the heating element 1810 accordingly. The client device can alternatively or additionally generate and send other data to the heating element control system 2005, such as the temperature data and/or other weather data, geolocation data, user calendar data, the clock data, and/or the learned user preference data. In some cases, the GUI 2159 can prompt the user to enter some or all of this other data manually and/or can prompt the user to select whether to some or all of this data to the heating element control system 2005. In the example GUI 2159 depicted in FIG. 21A, the user is prompted to select whether to send weather data, collected by the client device 2150 via an Internet connection and/or based on geolocation data collected by the client device 2150, to the heating element control system 2005.

As illustrated in FIG. 21A, the user selection data can be sent by the client device 2150 to the heating element control system 2005 via a wireless connection. This can include sending the user selection data to the heating element control system 2005 via low-power radio waves, a short-range wireless signal, and/or a wireless network and/or cellular connection. For example, the client device 2150 can pair to the heating element control system 2005 via a Bluetooth connection and/or another wireless connection. Alternatively or in addition, the client device 2150 can send the user selection data to the heating element control system 2005 via a wired connection with the heating element control system 2005.

In some cases, the wireless connection with heating element control system 2005 can enable the client device 2150 to remotely turn on the heating element 1810, for example, while still in the storage configuration inside the user's vehicle and when the user is not yet back to their vehicle. For example, the user can select that the heating element 1810 begin warming up to ensure the heating element 1810 is sufficiently warm once the user has arrived at their vehicle and is ready to change out of their footwear. In some cases, the heating element control system 2005 automatically turn the heating element 1810 to enable the heating element 1810 to automatically begin warming up based on the heating element control system 2005 detecting the client device 2150 is in range and/or based on pairing to the heating element control system 2005 via a Bluetooth connection.

As a particular example, based on user selection data and/or learned user preference data, the client device 2150 and/or the heating element control system 2005 can determine that the user tends to ski until the ski lifts close while engaging in ski activities, and prefers to have the heating element 1810 preheated upon their arrival back to their vehicle when they will assume usage of the multi-layer mat 100 in the usage configuration. The client device 2150 and/or the heating element control system 2005 can automatically determine a particular ski resort the user is skiing on a particular day based on calendar data stored in the client device 2150, based on geolocation data collected by the client device 2150 and/or a geolocation sensor communicating with heating element control system 2005, and/or based on learned behavior of the user. The client device 2150 and/or the heating element control system 2005 can determine the lift closing time of the particular ski resort based on user selection data, based on tracking previous visits by the user to the particular ski resort, and/or based on data received via the Internet indicating the ski resorts lift operation hours. The heating element control system 2005 can receive this information as scheduling data and can compare this information to clock data received from clock 2054 to determine that the lifts at the particular ski resort have closed, and to cause the heating element control system 2005 to automatically turn the heating element 1810 to enable the heating element 1810 to automatically begin warming up at this determined lift closing time or a predetermined time interval after this determined lift closing time. For example, the predetermined time interval after this determined lift closing time can be automatically determined based on a determined position of the multi-layer mat 100 and/or the user's vehicle relative to the bottom of a ski run and/or tracked historical time for the user to arrive at the car after the ski lifts have closed.

FIG. 21B presents an embodiment of client device 2150 of FIG. 21A. The client device 2150 can include a client memory module 2154 that stores application data 2155. For example, the application data 2155 is associated with the multi-layer mat 100 and/or the heating element control system 2005. The application data 2155 can be received by the multi-layer mat via the Internet and can be downloaded by the client device 2150 for execution via a client processing module 2152 of the client device 2150. The client processing module 2152 can execute the application data 2155, to cause the client device 2150 to display GUI 2159 via a client display device 2158 of the client device, to generate the user selection data based on user input to the client device 2150 in response to one or more prompts displayed by GUI 2159, and/or to transmit the user selection data to the heating element control system 2005 via a client communication interface via a wired and/or wireless connection with heating element control system 2005. The client processing module 2152, client memory module 2154, client communication interface 2156, and/or client display device 2158 can be connected via a bus 2151.

In various embodiments, the multi-layer mat 100 includes a heating element control system. The heating element control system includes a communication interface configured to receive user selection data from a user input device. The user selection data indicates one of a plurality of heat level options selected by the user via interaction with the user input device.

In various embodiments, the user input device is a cellular device that executes application data causing the cellular device to display a graphical user interface to the user via a display device of the cellular device. The cellular device presents a prompt to select the one of the plurality of heat level options via the graphical user interface; generates the user selection data based on user input to the graphical user interface in response to the prompt; and transmits the user selection data in a data signal to the heating element control system via a wireless connection with the communication interface the heating element control system.

FIGS. 22-24 illustrate embodiments of a multi-layer mat 100 that includes at least one heating element compartment 2230 that stores at least one heating element 2240. The embodiments of a multi-layer mat 100 with heating element compartment 2230 of FIGS. 22-24 can be utilized to implement the multi-layer mat 100 of FIG. 1 instead of or in addition to any other features and/or embodiments of the multi-layer mat 100 discussed herein.

Some or all of the features and/or functionality of heating element 2240 can be the same or different from any of the embodiments of the heating element 1810 discussed in conjunction with FIGS. 18A-21B. However, unlike the heating element 1810 discussed in conjunction with FIGS. 15-17 that is integrated permanently or semi-permanently within the multi-layer mat 100, the heating element 2240 can be easily inserted and removed from a heating element compartment 2230. For example, the heating element 2240 can be an element of the multi-layer mat 100 that is configured to be removed from the multi-layer mat 100. Alternatively, the heating element 2240 can be a user-supplied heating element, for example, that is not part of the multi-layer mat 100 and that the user is repurposing. The implementation of heating via a removable heating element 2240 can be ideal because it allows custom configuration of the heating element itself based on user preferences, because existing heating element already owned by the user can be repurposed, and/or because easy removal of heating element 2240 can cause the multi-layer mat 100 to be more easily rolled and/or folded into its storage configuration.

The heating element 2240 can be a metallic resistance heating element, a chemical heating element that generates heat via a chemical reaction, and/or any other heating element. Transitioning to the usage configuration of the multi-layer mat 100 can include activating and/or inserting at least one heating element 2240 into at least one heating element compartment 2230 to warm the user's feet in a same or similar fashion as discussed with regards to the heating element 1810 of FIGS. 18A-21B. Transitioning to the storage configuration of the multi-layer mat 100 can include removing at least one heating element 2240 into at least one heating element compartment 2230.

As a particular example, and as depicted in FIGS. 22-24, the heating element 2240 can be implemented by utilizing hand warmers, such as hand warmers belonging to the user and/or utilized by the user during winter activities such as skiing and/or snowboarding. The heating element 2240 can implemented via a battery-operated hand warmer or other battery operated heating element. In some cases, the heating element 2240 can implemented via a hand warmer or other heating element that utilizes a supersaturated solution, iron, and/or charcoal. The heating element 2240 can implemented via a disposable air-activated hand warmer or other disposable air-activated heating element. For example, the user may have several extra disposable hand warmers available based on skiing and/or snowboarding regularly, and as these disposable hand warmers may be relatively inexpensive, the user can activate unused hand warmers for use as heating elements 2240. As another example, the user may have used hand warmers during their activity, and these hand warmers may still be sufficiently hot. After the activity has completed and the user is utilizing the multi-layer mat in the usage configuration, the user can insert these used, yet still effective, hand warmers into heating element compartment 2230 to warm the user's feet. This process can be similarly applied to reusable hand warmers such as battery-operated hand warmer that were utilized by the user during their activity and that still have sufficient charge to be used as heating elements 2240 to warm the user's feet.

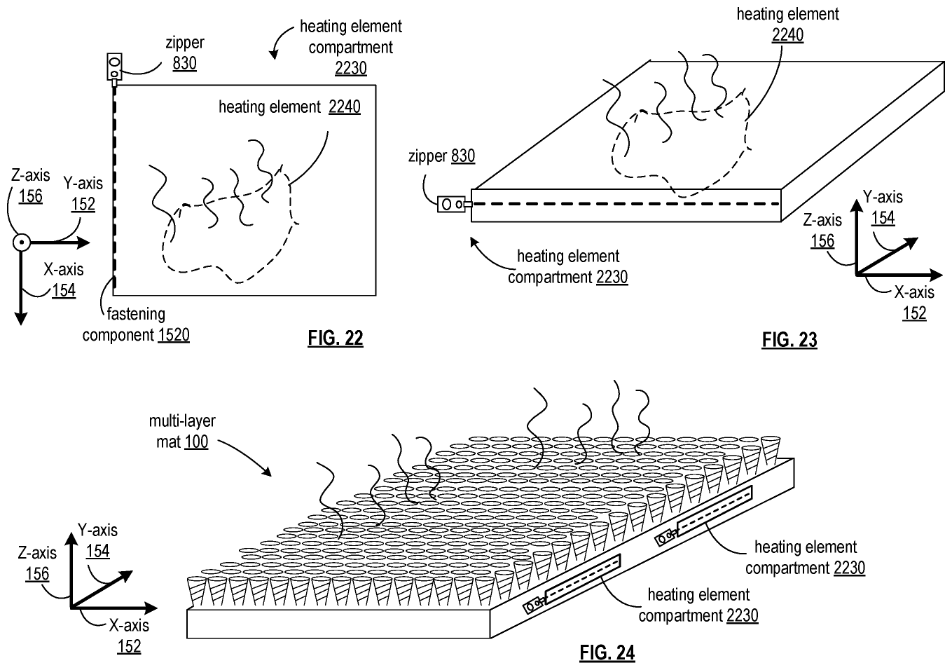

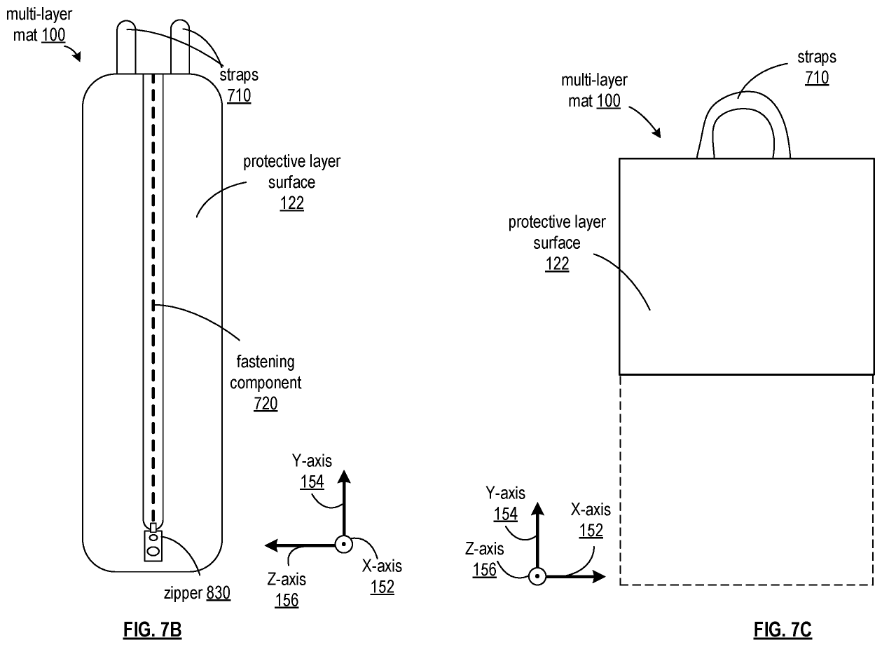

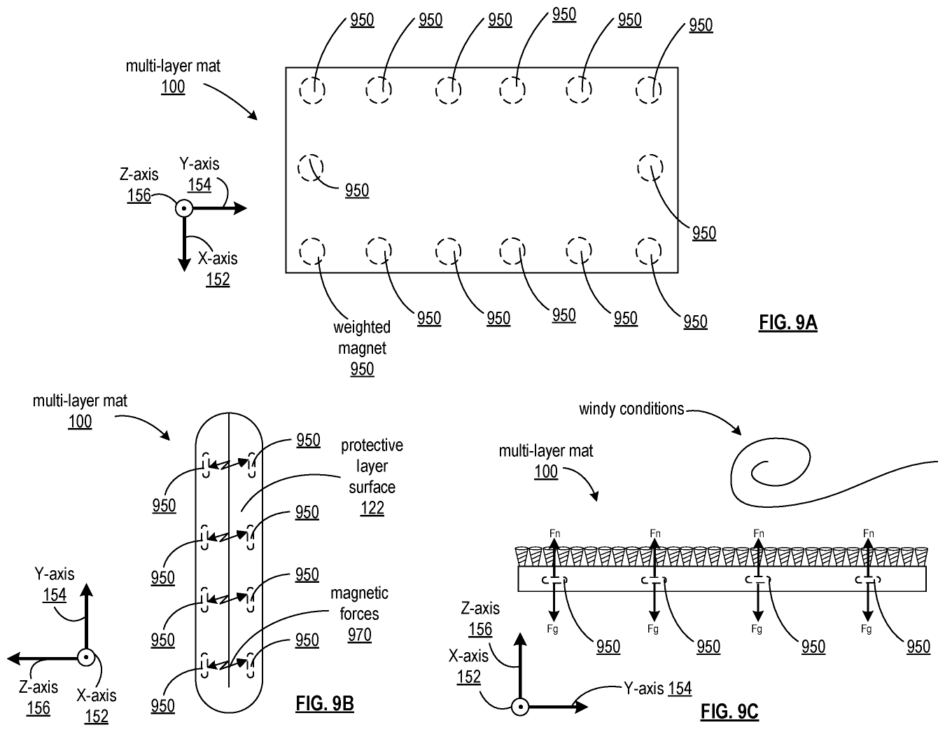

FIG. 22 depicts a top view of a heating element compartment 2230, FIG. 23 illustrates a three-dimensional view of a heating element compartment 2230, and FIG. 24 presents a view of multi-layer mat 100 that includes at least one heating element compartment 2230 accessible via a side of the multi-layer mat. The heating element compartment 2230 can have some or all of the same features and/or functionality of the storage compartment 1530 of FIGS. 15-17, and FIGS. 22, 23, and/or 24 can correspond to FIGS. 15, 16 and/or 17, respectively.

In some cases, heating element compartment 2230 can correspond to an enhanced storage compartment 1530 that is further configured to store a heating element 2240. For example, the heating element compartment 2230 and can be lined with heat-protected liner and/or an insulating liner to protect other portions of the multi-layer mat and/or the user's feet from direct contact with the heating element 2240. As another example, the heating element compartment 2230 can be lined with a conductive liner to aid in propagate heat to the comfort layer surface 112 to better warm the user's feet. As another example, the heating element compartment 2230 can be sized and/or shaped based on known dimensions of heating element 2240. As another example the heating element compartment 2230 can be positioned directly under comfort layer 120 and/or within comfort layer 120 to provide closest proximity of the user's feet to the heating element 2240 as possible to best warm the user's feet.

In the example illustrated in FIG. 24, the multi-layer mat 100 includes exactly two heating element compartments 2230. These heating element compartments 2230 can be positioned based on aligning under where the user stands with their two feet. For example, insertion of heating elements 2240 within each of these heating element compartments 2230 can be utilized to implement the embodiment of multi-layer mat 100 depicted in FIG. 19, for example, where a visual markers 1920 are positioned directly above the heating element compartments 2230.

In various embodiments, the multi-layer mat 100 includes at least one heating element compartment configured to secure at least one removable heating element while in the usage configuration to warm at least one foot of the user. The manual transition between the usage configuration and the storage configuration includes removal of the at least one removable heating element from the at least one heating element compartment.

It is noted that terminologies as may be used herein such as bit stream, stream, signal sequence, etc. (or their equivalents) have been used interchangeably to describe digital information whose content corresponds to any of a number of desired types (e.g., data, video, speech, text, graphics, audio, etc. any of which may generally be referred to as ‘data’).

As may be used herein, the terms “substantially” and “approximately” provides an industry-accepted tolerance for its corresponding term and/or relativity between items. For some industries, an industry-accepted tolerance is less than one percent and, for other industries, the industry-accepted tolerance is 10 percent or more. Other examples of industry-accepted tolerance range from less than one percent to fifty percent. Industry-accepted tolerances correspond to, but are not limited to, component values, integrated circuit process variations, temperature variations, rise and fall times, thermal noise, dimensions, signaling errors, dropped packets, temperatures, pressures, material compositions, and/or performance metrics. Within an industry, tolerance variances of accepted tolerances may be more or less than a percentage level (e.g., dimension tolerance of less than +/−1%). Some relativity between items may range from a difference of less than a percentage level to a few percent. Other relativity between items may range from a difference of a few percent to magnitude of differences.

As may also be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”.

As may even further be used herein, the term “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item.

As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1. As may be used herein, the term “compares unfavorably”, indicates that a comparison between two or more items, signals, etc., fails to provide the desired relationship.

As may be used herein, one or more claims may include, in a specific form of this generic form, the phrase “at least one of a, b, and c” or of this generic form “at least one of a, b, or c”, with more or less elements than “a”, “b”, and “c”. In either phrasing, the phrases are to be interpreted identically. In particular, “at least one of a, b, and c” is equivalent to “at least one of a, b, or c” and shall mean a, b, and/or c. As an example, it means: “a” only, “b” only, “c” only, “a” and “b”, “a” and “c”, “b” and “c”, and/or “a”, “b”, and “c”.

As may also be used herein, the terms “processing module”, “processing circuit”, “processor”, “processing circuitry”, and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, processing circuitry, and/or processing unit may be, or further include, memory and/or an integrated memory element, which may be a single memory device, a plurality of memory devices, and/or embedded circuitry of another processing module, module, processing circuit, processing circuitry, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, processing circuitry, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, processing circuitry and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, processing circuitry and/or processing unit executes, hard coded and/or operational instructions corresponding to at least some of the steps and/or functions illustrated in one or more of the Figures. Such a memory device or memory element can be included in an article of manufacture.

One or more embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof.

In addition, a flow diagram may include a “start” and/or “continue” indication. The “start” and “continue” indications reflect that the steps presented can optionally be incorporated in or otherwise used in conjunction with one or more other routines. In addition, a flow diagram may include an “end” and/or “continue” indication. The “end” and/or “continue” indications reflect that the steps presented can end as described and shown or optionally be incorporated in or otherwise used in conjunction with one or more other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

The one or more embodiments are used herein to illustrate one or more aspects, one or more features, one or more concepts, and/or one or more examples. A physical embodiment of an apparatus, an article of manufacture, a machine, and/or of a process may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of one or more of the embodiments. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

As may further be used herein, a computer readable memory includes one or more memory elements. A memory element may be a separate memory device, multiple memory devices, or a set of memory locations within a memory device. Such a memory device may be a read-only memory, random access memory, volatile memory, non-volatile memory, static memory, dynamic memory, flash memory, cache memory, a quantum register or other quantum memory and/or any other device that stores data in a non-transitory manner. Furthermore, the memory device may be in a form of a solid-state memory, a hard drive memory or other disk storage, cloud memory, thumb drive, server memory, computing device memory, and/or other non-transitory medium for storing data. The storage of data includes temporary storage (i.e., data is lost when power is removed from the memory element) and/or persistent storage (i.e., data is retained when power is removed from the memory element). As used herein, a transitory medium shall mean one or more of: (a) a wired or wireless medium for the transportation of data as a signal from one computing device to another computing device for temporary storage or persistent storage; (b) a wired or wireless medium for the transportation of data as a signal within a computing device from one element of the computing device to another element of the computing device for temporary storage or persistent storage; (c) a wired or wireless medium for the transportation of data as a signal from one computing device to another computing device for processing the data by the other computing device; and (d) a wired or wireless medium for the transportation of data as a signal within a computing device from one element of the computing device to another element of the computing device for processing the data by the other element of the computing device. As may be used herein, a non-transitory computer readable memory is substantially equivalent to a computer readable memory. A non-transitory computer readable memory can also be referred to as a non-transitory computer readable storage medium.

While particular combinations of various functions and features of the one or more embodiments have been expressly described herein, other combinations of these features and functions are likewise possible. The present disclosure is not limited by the particular examples disclosed herein and expressly incorporates these other combinations.

What is claimed is:

1. A multi-layer mat, comprising:
a protective layer composed of a first material and having a protective layer surface; and
a comfort layer atop the protective layer, composed of a second material that includes a plurality of fabric fibers and that is distinct from the first material, and having a comfort layer surface parallel to the protective layer surface;
wherein, in a usage configuration of the multi-layer mat, the multi-layer mat is configured to lie flat upon a planar ground surface with the protective layer surface flush against the planar ground surface and with the comfort layer surface exposed to facilitate standing upon by at least one unprotected foot of a user of the multi-layer mat, wherein the protective layer is configured to protect the at least one unprotected foot from elements of the planar ground surface while in the usage configuration via the first material; and
wherein the multi-layer mat is configured for manual transition between the usage configuration and a storage configuration via the user, and wherein the storage configuration is different from the usage configuration.

2. The multi-layer mat of claim 1, wherein, in the usage configuration of the multi-layer mat, the protective layer surface is included in a first plane upon the planar ground surface and the comfort layer surface is included in a second plane parallel to the first plane, and wherein a segment between a center of the protective layer surface and a center of the comfort layer surface is perpendicular to the first plane and the second plane.

3. The multi-layer mat of claim 1, wherein the first material includes at least one of: a non-porous rubber material, a water-resistant plastic material, or a waterproof plastic material.

4. The multi-layer mat of claim 1, wherein the plurality of fabric fibers are implemented via a plurality of fabric piles, and wherein the comfort layer is configured to remove moisture from the at least one unprotected foot while in the usage configuration via the plurality of fabric piles.

5. The multi-layer mat of claim 1, further comprising at least one internal layer between the comfort layer and the protective layer.

6. The multi-layer mat of claim 5, wherein the at least one internal layer includes at least one of: at least one foam element, a plurality of microbeads, a plurality of down feather elements, or at least one inflatable element.

7. The multi-layer mat of claim 5, wherein the at least one internal layer includes at least one heating element configured to warm the at least one unprotected foot of the user in the usage configuration.

8. The multi-layer mat of claim 7, wherein the at least one internal layer is configured to be powered via at least one of: a wired alternating current (AC) power connection to an AC power outlet, a wired direct current (DC) power connection to an automobile auxiliary power outlet of an automobile, or a battery included in the at least one internal layer of the multi-layer mat.

9. The multi-layer mat of claim 7, wherein the multi-layer mat further comprises a heating element control system and at least one of: a current sensor configured to capture current measurements of the heating element, a voltage sensor configured to capture voltage measurements of the heating element, or a temperature sensor configured to capture temperature measurements, and wherein the heating element control system dynamically adjusts a current delivered to the heating element in accordance with a predetermined heat level to be outputted by the heating element based on at least one of: the current measurements, the voltage measurements, or the temperature measurements.

10. The multi-layer mat of claim 9, wherein the current is delivered to the heating element via a heating element driver circuit, and wherein the current is dynamically adjusted via at least one of: a potentiometer of the heating element driver circuit, a rheostat of the heating element driver circuit, or a voltage regulator of the heating element driver circuit.

11. The multi-layer mat of claim 9, wherein the heating element control system includes a communication interface configured to receive user selection data from a user input device, wherein the user selection data indicates one of a plurality of heat level options selected by the user via interaction with the user input device.

12. The multi-layer mat of claim 11, wherein the user input device is a cellular device that executes application data causing the cellular device to display a graphical user interface to the user via a display device of the cellular device, wherein the cellular device:
presents a prompt to select the one of the plurality of heat level options via the graphical user interface;
generates the user selection data based on user input to the graphical user interface in response to the prompt; and
transmits the user selection data in a data signal to the heating element control system via a wireless connection with the communication interface the heating element control system.

13. The multi-layer mat of claim 1, further comprising at least one strap configured to enable carrying of the multi-layer mat by the user while in the storage configuration.

14. The multi-layer mat of claim 13, wherein the at least one strap is further configured to secure the multi-layer mat to at least one of: a boot, a car tire, or a tailgate hitch while in the usage configuration.

15. The multi-layer mat of claim 1, further comprising at least one fastening component configured to secure the multi-layer mat in the storage configuration.

16. The multi-layer mat of claim 15, wherein the at least one fastening component includes a supplemental weight and is further configured to secure the multi-layer mat against the planar ground surface via gravitational forces induced on the at least one fastening component.

17. The multi-layer mat of claim 1, wherein the storage configuration includes one of: a folded configuration wherein the protective layer surface is exposed and wherein one portion of the comfort layer surface lies flush to a second portion of the comfort layer surface, or a rolled configuration wherein the protective layer surface is exposed as an outer surface of the rolled configuration.

18. The multi-layer mat of claim 1, wherein the comfort layer is removable, wherein a reverse-side surface of the comfort layer that is parallel to and opposite the comfort layer surface includes a protective material that is distinct from the second material, wherein, in the usage configuration, the comfort layer is attached in a first orientation via at least one fastening component to expose the comfort layer surface, and wherein, in the storage configuration, the comfort layer is attached via the at least one fastening component in a flipped orientation from the first orientation to expose the reverse-side surface.

19. The multi-layer mat of claim 1, further comprising at least one storage compartment configured to secure at least one personal item of the user.

20. The multi-layer mat of claim 1, further comprising at least one heating element compartment configured to secure at least one removable heating element while in the usage configuration to warm the at least one unprotected foot of the user, wherein the manual transition between the usage configuration and the storage configuration includes removal of the at least one removable heating element from the at least one heating element compartment.
